(19) United States
(12) Patent Application Publication
(10) Pub. No.: US 2022/0323978 A1
(43) Pub. Date: Oct. 13, 2022

(54) SPRAYING APPARATUS WITH REMOTE RESERVOIR

(71) Applicants: SAINT-GOBAIN ABRASIVES, INC., Worcester, MA (US); SAINT-GOBAIN ABRASIFS, Conflans-Sainte-Honorine (FR)

(72) Inventors: Stefano GIANZINI, Milan (IT); Axel SANGALLI, Gallarate (IT); Dario MARZORATI, Milan (IT)

(21) Appl. No.: 17/633,845

(22) PCT Filed: Aug. 7, 2020
(86) PCT No.: PCT/US2020/045381

§ 371 Date: Feb. 8, 2022

Related U.S. Application Data
(60) Provisional application No. 62/884,482, filed on Aug. 8, 2019.

(51) Int. Cl. B05B 7/24; B05B 12/00

(52) U.S. Cl. CPC B05B 7/241; B05B 12/008; B05B 7/2475; B05B 7/2481

(57) ABSTRACT

Systems and methods are disclosed that include a spraying apparatus having a hand held spraying device, a flexible reservoir connected in fluid communication with the hand held spraying device and worn on the body of a user of the spraying apparatus, and a pressure device that provides pressure to the flexible reservoir to move fluid from the flexible reservoir to the hand held spraying device.

### BACKGROUND ART

Hand held spraying devices are used in various industries to spray a wide array of chemicals and/or fluids (e.g., insecticides, liquid fertilizers, lacquers, paints, stains, etc.). Such hand held spraying devices often have a fluid reservoir mounted directly to the hand held spraying device. The weight of the hand held spraying device combined with the weight of the fluid carried in the fluid reservoir can be significant. As such, continuous or extended periods of use can result in user fatigue, which can lead to a reduction in the quality of workmanship or even an increase in the risk of injury.

### SUMMARY

The present invention relates to a spraying apparatus, and in particular, to having a hand held spraying device and remote reservoir that may be carried, worn, or otherwise secured to a body of a user.

Embodiments of a spraying apparatus disclosed herein may include: a hand held spraying device; a reservoir assembly comprising a flexible reservoir connected in fluid communication with the hand held spraying device, wherein the flexible reservoir is configured to be worn on the body of a user of the spraying apparatus; and a pressure device configured to provide pressure to the flexible reservoir. Embodiments of a spraying apparatus disclosed herein may include: a hand held spraying device; and a reservoir assembly, comprising: a rigid tank; a flexible reservoir received within the rigid tank and connected in fluid communication with the hand held spraying device; a pump configured to provide pressure to the flexible reservoir; and a pressure regulator configured to regulate the pressure provided by the pump to the flexible reservoir; wherein the reservoir assembly is configured to be worn on the body of a user of the spraying apparatus.

Embodiments of a method of operating a spraying apparatus may include: providing a reservoir assembly comprising a flexible reservoir; securing the reservoir assembly to the body of a user; connecting the flexible reservoir in fluid communication with a hand held spraying device; selectively adjusting the pressure supplied to the flexible reservoir; and operating a mechanism of the hand held spraying device to discharge a fluid carried by the flexible reservoir from the hand held spraying device.

### BRIEF DESCRIPTION OF THE DRAWINGS

So that the manner in which the features and advantages of the embodiments are attained and can be understood in more detail, a more particular description may be had by reference to the embodiments thereof that are illustrated in the appended drawings. However, the drawings illustrate only some embodiments and therefore are not to be considered limiting in scope as there may be other equally effective embodiments. The use of the same reference symbols in different drawings indicates similar or identical items.

FIG. 1 shows schematic front, right, and rear views of a spraying apparatus carried by a user according to an embodiment of the disclosure.

FIG. 2 is a side view of a hand held spraying device according to an embodiment of the disclosure.

FIG. 3 is an oblique exploded view of a reservoir assembly according to another embodiment of the disclosure.

FIG. 4 is an oblique exploded view of a reservoir assembly according to another embodiment of the disclosure.

FIG. 5 is a cross-sectional front view of a reservoir assembly according to an embodiment of the disclosure.

FIG. 6 is a cross-sectional front view of a reservoir assembly according to another embodiment of the disclosure.

FIG. 7 is a schematic side view of a spraying apparatus according to an alternative embodiment of the disclosure.

FIG. 8 is a schematic side view of a spraying apparatus according to another alternative embodiment of the disclosure.

FIG. 9 is a flowchart of a method of operating a spraying apparatus according to an embodiment of the disclosure.

FIG. 10 is a schematic side view of a reservoir assembly according to an embodiment of the disclosure.

FIG. 11 is a schematic side view of a mixing apparatus according to an embodiment of the disclosure.

FIG. 12 is an oblique view of a reservoir assembly according to another embodiment of the disclosure.

FIG. 13 is an oblique view of a reservoir assembly according to another embodiment of the disclosure.

FIG. 14 is an oblique view of a cover of a reservoir assembly according to an embodiment of the disclosure.

FIG. 15 is an oblique exploded view of a cover of a reservoir assembly according to an embodiment of the disclosure.

### DETAILED DESCRIPTION OF THE PREFERRED EMBODIMENT(S)

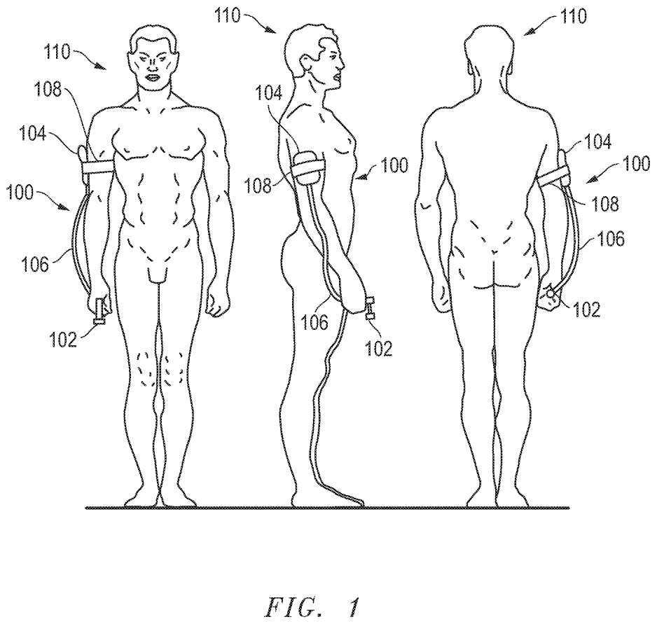

FIG. 1 shows front, side, and rear views of a spraying apparatus 100 carried by a user 110 according to an embodiment of the disclosure. The spraying apparatus 100 may generally comprise a hand held spraying device 102, a reservoir assembly 104, a flexible tube 106 connecting the hand held spraying device 102 and the reservoir assembly 104 in fluid communication, and a pressure device 108.

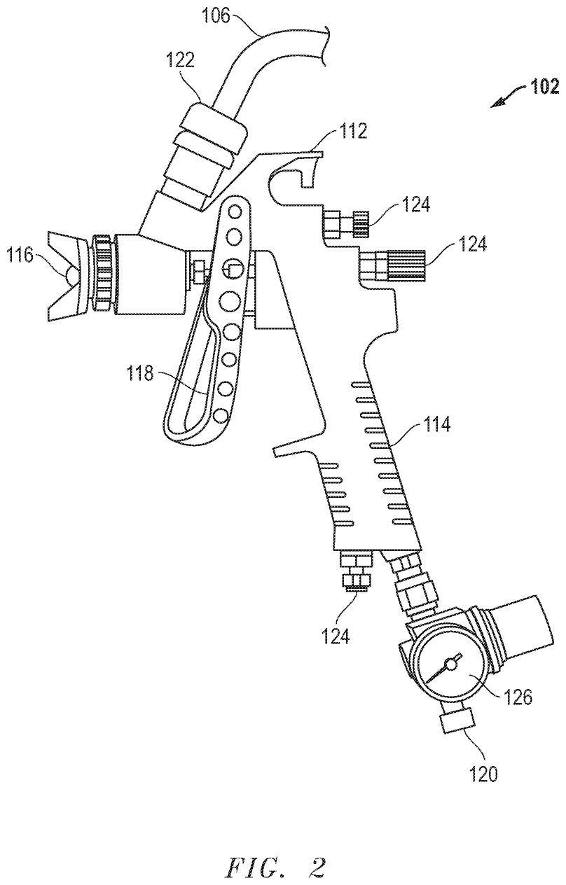

FIG. 2 shows a side view of the hand held spraying device 102 according to an embodiment of the disclosure. In some embodiments, the hand held spraying device 102 may be specially adapted to connect to the reservoir assembly 104 via the tube 106. However, in other embodiments, the hand held spraying device 102 may be a traditional hand held spraying device as known in the art. The hand held spraying device 102 may generally comprise a body 112 having a handle 114, a nozzle 116, and a mechanism 118 (e.g., lever, trigger, etc.). The hand held spraying device 102 may also comprise a first inlet 120 for connection to pressure source (e.g., air compressor, etc.—not shown). In some embodiments, the pressure source may comprise an air compressor as known in the art for supplying pressurized air to the hand held spraying device 102 to discharge and/or propel fluid carried by the flexible reservoir 104 through the nozzle 116 of the hand held spraying device 102. The hand held spraying device 102 may also comprise a second inlet 122 for connection to the reservoir assembly 104 via the tube 106. Further, the hand held spraying device 102 may also comprise one or more selectively adjustable knobs 124 for selectively adjusting operation parameters of the hand held spraying device 102. In some embodiments, knobs 124 may selectively adjust inlet pressure at the first inlet 120 and/or the second inlet 122, outlet pressure at the nozzle 116, spray pattern, and/or travel of the mechanism 118. Furthermore, in some embodiments, the hand held spraying device 102 may comprise a pressure instrument 126 (e.g., gauge, pressure regulator, pressure relief valve, or any combination thereof).

As shown in FIG. 1, the reservoir assembly 104 may generally be configured to be worn by a user 110. For example, in some embodiments, the reservoir assembly 104 may be worn on an arm of the user 110. In some embodiments, the reservoir assembly 104 may be worn on the back of the user 110. However, in other embodiments, the reservoir assembly 104 may be worn on a forearm, a leg, or the waist of the user 110. It will be appreciated that the reservoir assembly 104 may comprise appropriate bands, belts, cuffs, straps, and/or other mounting devices that securely attach the reservoir assembly 104 to the user 110. For example, in the embodiment shown, the reservoir assembly 104 is secured around the arm of the user 110 by a resilient band. In some embodiments, the reservoir assembly 104 may be secured to the back of the user 110 by shoulder straps. In other embodiments, the reservoir assembly 104 may be secured to the waist of the user 110 by a belt. In alternative embodiments, the reservoir assembly 104 may be hung, mounted, or otherwise secured to a door, a vehicle, a wall, and/or other stationary structure. Additionally, in some embodiments, the reservoir assembly 104 may comprise appropriate bands, belts, cuffs, straps, and/or other mounting devices that allow the reservoir assembly 104 to be worn in multiple locations on the user 110 based on the preference of the user 110. Because the reservoir assembly 104 is not carried by or directly mounted to the hand held spraying device 102, it will be appreciated that the reservoir assembly 104 may be referred to as a remote reservoir assembly. In the embodiment shown, the reservoir assembly 104 comprises a flexible or pliable fluid reservoir. As such, in some embodiments, the reservoir assembly 104 may be formed from a pliable material, such as low-density polyethylene (LDPE). The reservoir assembly 104 may generally be configured to carry a volume of fluid (e.g., lacquer, paint, stain, or other cosmetic enhancing fluid) until the fluid is discharged through the hand held spraying device 102. In some embodiments, the reservoir assembly 104 may comprise a volume of at least about 150 cubic centimeters, such as at least about 200 cubic centimeters, at least about 250 cubic centimeters, at least about 300 cubic centimeters, at least about 350 cubic centimeters, at least about 500 cubic centimeters, at least about 750 cubic centimeters, or at least about 1000 cubic centimeters, at least about 1500 cubic centimeters, at least about 2000 cubic centimeters, or even at least about 2500 cubic centimeters. Furthermore, in some embodiments, the reservoir assembly 104 may be sealable and/or resealable.

The tube 106 may generally connect the reservoir assembly 104 in fluid communication with the hand held spraying device 102. More specifically, the tube 106 may connect the reservoir assembly 104 in fluid communication with the second inlet 122 of the hand held spray device 102. In some embodiments, the tube 106 may comprise an inner diameter of at least about 3 millimeters, such as at least about 4 millimeters, at least about 5 millimeters, at least about 6 millimeters, at least about 7 millimeters, at least about 8 millimeters, at least about 9 millimeters, at least about 10 millimeters, at least about 12 millimeters, at least about 15 millimeters, at least about 20 millimeters, or even at least about 25 millimeters. Further, in some embodiments, the tube 106 may comprise a length of at least about 0.50 meters, such as at least about 0.75 meters, at least about 1 meter, at least about 1.5 meters, at least about 2 meters, at least about 3 meters, at least about 4 meters, at least about 5 meters, or even at least about 10 meters.

The pressure device 108 may generally be configured to provide pressure to the reservoir assembly 104. In the embodiment shown, the pressure device 108 comprises a resilient band or strap. For example, in an embodiment, the pressure device 108 comprises an elastic band. However, in other embodiments, the pressure device 108 may comprise a plate, a rotatable splined shaft, a spring, a pump (e.g., manual, electric, electro-mechanical, hydraulic, etc.), an air compressor, or any other device capable of providing pressure to the reservoir assembly 104. The resilient band or strap may also be configured to secure the reservoir assembly 104 to the user 110. As such, the resilient band or strap extends at least partially around the reservoir assembly 104 to provide pressure to the flexible reservoir 104 and at least partially around a portion of the body of the user 110 to secure the flexible reservoir 104 to the body of the user 110. In the embodiment shown, the resilient band or strap is securing the flexible reservoir 104 to the arm of the user 110.

In some embodiments, the pressure device 108 may be configured to provide sufficient pressure to the reservoir assembly 104 to move fluid from an internal volume of the reservoir assembly 104, through the tube 106, and to the hand held spraying device 102. However, in some embodiments, the pressure device 108 may not provide adequate pressure to discharge the fluid from the hand held spraying device 102. Accordingly, in some embodiments, the pressure device 108 may provide at least 1 meter of H₂O pressure (about 1.42 pounds per square inch), such as at least 1.5 meters of H₂O pressure (about 2.13 pounds per square inch), at least 2 meters of H₂O pressure (about 2.84 pounds per square inch), at least 3 meters of H₂O pressure (about 4.27 pounds per square inch), at least 4 meters of H₂O pressure (about 5.69 pounds per square inch), at least 5 meters of H₂O pressure (about 7.11 pounds per square inch), or at least 10 meters of H₂O pressure (about 14.22 pounds per square inch). In some embodiments, the pressure device 108 may provide not greater than 70.31 meters of H₂O pressure (about 100 pounds per square inch), such as not greater than 42.18 meters of H₂O pressure (about 60 pounds per square inch), not greater than 31.64 meters of H₂O pressure (about 45 pounds per square inch), not greater than 28.12 meters of H₂O pressure (40 pounds per square inch), not greater than 24.61 meters of H₂O pressure (30 pounds per square inch), not greater than 17.58 meters of H₂O pressure (25 pounds per square inch), or not greater than 14.06 meters of H₂O pressure (20 pounds per square inch). It will be appreciated that the pressure device 108 may provide pressure between any of these minimum and maximum values.

Additionally, while not shown, the spraying apparatus 100 and/or the pressure device 108 may also comprise a pressure gauge, pressure regulator, a pressure relief valve, or a combination thereof. The pressure gauge, pressure regulator, pressure relief valve, or combination thereof may generally assist the user 110 in maintaining proper pressure in the reservoir assembly 104 and/or controlling the flow of a fluid from the reservoir assembly 104 to the hand held spray device 102.

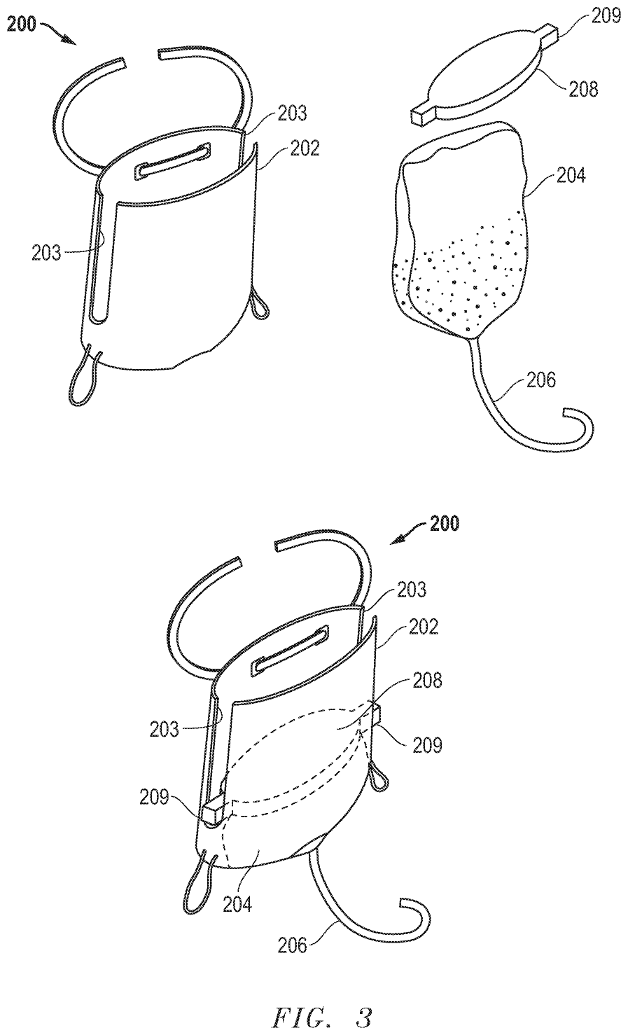

FIG. 3 shows an oblique exploded view of a reservoir assembly 200 according to another embodiment of the disclosure. The reservoir assembly 200 may generally comprise a rigid tank 202, a flexible reservoir 204 received within the rigid tank 202, a tube 206 connecting the flexible reservoir 204 in fluid communication with a hand held spraying device 102, and a pressure device 208. The reservoir assembly 200 may generally be configured to be worn by a user 110 in a substantially similar manner to reservoir assembly 104. Accordingly, it will be appreciated that the rigid tank 202 may comprise appropriate bands, belts, cuffs, straps, and/or other mounting devices that securely attach the reservoir assembly 200 to the user 110. In some embodiments, the rigid tank 202 may be formed from a thermoplastic or thermosetting material (e.g., polyethylene).

In some embodiments, the flexible reservoir 204 may be substantially similar to the reservoir assembly 104 but may be received within and be removable from the rigid tank 202. Accordingly, in some embodiments, the rigid tank 202 may be configured to receive various sized flexible reservoirs 202. The flexible reservoir 204 may generally be formed from a pliable material, such as low-density polyethylene (LDPE). As such, an internal volume of the flexible reservoir 204 may be selectively adjustable by the pressure device 208 as fluid is discharged from the flexible reservoir 204. The flexible reservoir 204 may generally be configured to carry a volume of fluid (e.g., lacquer, paint, stain, or other cosmetic enhancing fluid) until the fluid is discharged through the hand held spraying device 102. In some embodiments, the flexible reservoir 204 may comprise a volume of at least about 150 cubic centimeters, such as at least about 200 cubic centimeters, at least about 250 cubic centimeters, at least about 300 cubic centimeters, at least about 350 cubic centimeters, at least about 500 cubic centimeters, at least about 750 cubic centimeters, or at least about 1000 cubic centimeters, at least about 1500 cubic centimeters, at least about 2000 cubic centimeters, or even at least about 2500 cubic centimeters. Furthermore, in some embodiments, the flexible reservoir 204 may be sealable and/or resealable.

The tube 206 may generally connect the flexible reservoir 204 in fluid communication with the hand held spraying device 102. More specifically, the tube 206 may connect the flexible reservoir 204 in fluid communication with the second inlet 122 of the hand held spray device 102. In some embodiments, the tube 206 may comprise an inner diameter of at least about 3 millimeters, such as at least about 4 millimeters, at least about 5 millimeters, at least about 6 millimeters, at least about 7 millimeters, at least about 8 millimeters, at least about 9 millimeters, at least about 10 millimeters, at least about 12 millimeters, at least about 15 millimeters, at least about 20 millimeters, or even at least about 25 millimeters. Further, in some embodiments, the tube 206 may comprise a length of at least about 0.50 meters, such as at least about 0.75 meters, at least about 1 meter, at least about 1.5 meters, at least about 2 meters, at least about 3 meters, at least about 4 meters, at least about 5 meters, or even at least about 10 meters.

In the embodiment shown, the pressure device 208 comprises a plate. The plate may be configured to be received within the rigid tank 202 and on top of the flexible reservoir 204. In some embodiments, the plate may be formed from a metal, metal alloy, or any other material that provides sufficient mass to pressurize the flexible reservoir 204 when placed on top of the flexible reservoir 204 within the rigid tank 202. In some embodiments, the plate may comprise extensions 209 that interface with slots 203 in the rigid tank 202 to align, level, and/or otherwise properly locate the plate with the rigid tank 202. When received within the rigid tank 202, the weight of the plate may generally be configured to provide sufficient pressure to the flexible reservoir 204 to move fluid from the internal volume of the flexible reservoir 204, through the tube 206, and to the hand held spraying device 102. However, in some embodiments, the pressure device 208 may not provide adequate pressure to discharge the fluid from the hand held spraying device 102. Accordingly, in some embodiments, the pressure device 208 may provide at least 1 meter of H₂O pressure (about 1.42 pounds per square inch), such as at least 1.5 meters of H₂O pressure (about 2.13 pounds per square inch), at least 2 meters of H₂O pressure (about 2.84 pounds per square inch), at least 3 meters of H₂O pressure (about 4.27 pounds per square inch), at least 4 meters of H₂O pressure (about 5.69 pounds per square inch), at least 5 meters of H₂O pressure (about 7.11 pounds per square inch), or at least 10 meters of H₂O pressure (about 14.22 pounds per square inch). In some embodiments, the pressure device 208 may provide not greater than 70.31 meters of H₂O pressure (about 100 pounds per square inch), such as not greater than 42.18 meters of H₂O pressure (about 60 pounds per square inch), not greater than 31.64 meters of H₂O pressure (about 45 pounds per square inch), not greater than 28.12 meters of H₂O pressure (40 pounds per square inch), not greater than 24.61 meters of H₂O pressure (30 pounds per square inch), not greater than 17.58 meters of H₂O pressure (25 pounds per square inch), or not greater than 14.06 meters of H₂O pressure (20 pounds per square inch). It will be appreciated that the pressure device 208 may provide pressure between any of these minimum and maximum values.

Additionally, while not shown, the flexible reservoir 204 and/or the pressure device 208 may also comprise a pressure gauge, pressure regulator, a pressure relief valve, or a combination thereof. The pressure gauge, pressure regulator, pressure relief valve, or combination thereof may generally assist the user 110 in maintaining proper pressure in the flexible reservoir 204 and/or controlling the flow of a fluid from the flexible reservoir 204 to the hand held spray device 102.

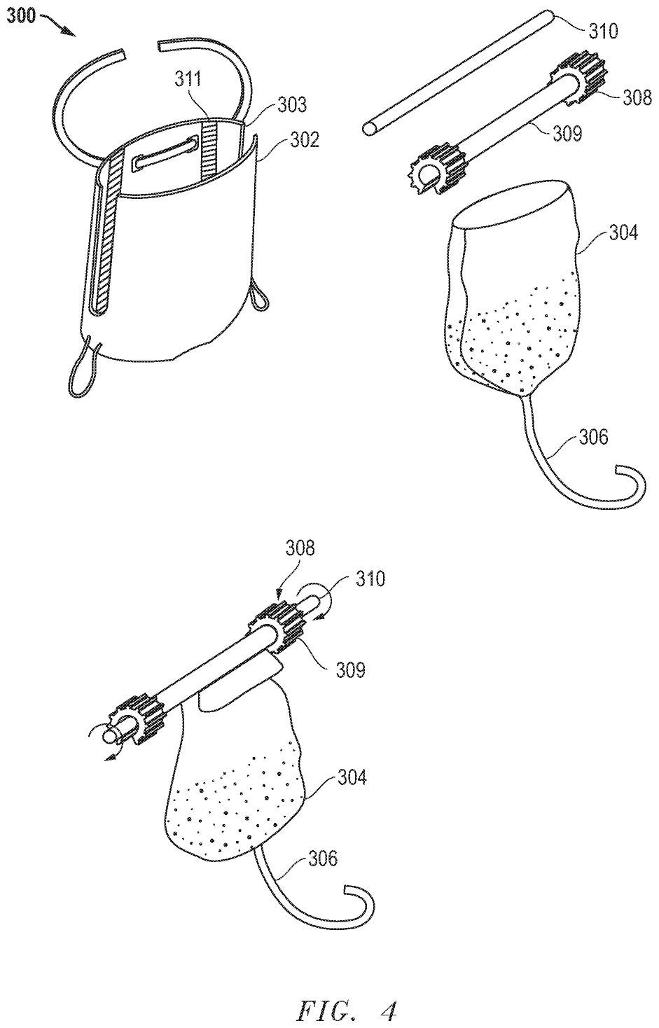

FIG. 4 shows an oblique exploded view of a reservoir assembly 300 according to another embodiment of the disclosure. The reservoir assembly 300 may generally be substantially similar to reservoir assembly 200 in that the reservoir assembly 300 comprises a rigid tank 302, a flexible reservoir 304 received within the rigid tank 302, a tube 306 connecting the flexible reservoir 304 in fluid communication with a hand held spraying device 102, and a pressure device 308. However, in the embodiment shown, the pressure device 308 comprises a splined shaft assembly. The reservoir assembly 300 may generally be configured to be worn by a user 110 in a substantially similar manner to reservoir assemblies 104, 204. Accordingly, it will be appreciated that the rigid tank 302 may comprise appropriate bands, belts, cuffs, straps, and/or other mounting devices that securely attach the reservoir assembly 300 to the user 110. In some embodiments, the rigid tank 302 may be formed from a thermoplastic or thermosetting material (e.g., polyethylene).

In some embodiments, the flexible reservoir 304 may substantially similar to the flexible reservoir 204 and be received within and be removable from the rigid tank 302.

Accordingly, in some embodiments, the rigid tank 302 may be configured to receive various sized flexible reservoirs 302. The flexible reservoir 304 may generally be formed from a pliable material, such as low-density polyethylene (LDPE). As such, an internal volume of the flexible reservoir 304 may be selectively adjustable by the pressure device 308 as fluid is discharged from the flexible reservoir 304. The flexible reservoir 304 may generally be configured to carry a volume of fluid (e.g., lacquer, paint, stain, or other cosmetic enhancing fluid) until the fluid is discharged through the hand held spraying device 102. In some embodiments, the flexible reservoir 304 may comprise a volume of at least about 150 cubic centimeters, such as at least about 200 cubic centimeters, at least about 250 cubic centimeters, at least about 300 cubic centimeters, at least about 350 cubic centimeters, at least about 500 cubic centimeters, at least about 750 cubic centimeters, or at least about 1000 cubic centimeters, at least about 1500 cubic centimeters, at least about 2000 cubic centimeters, or even at least about 2500 cubic centimeters. Furthermore, in some embodiments, the flexible reservoir 304 may be sealable and/or resealable.

The tube 306 may generally be substantially similar to the tube 206 and connect the flexible reservoir 304 in fluid communication with the hand held spraying device 102. More specifically, the tube 306 may connect the flexible reservoir 304 in fluid communication with the second inlet 122 of the hand held spray device 102. In some embodiments, the tube 306 may comprise an inner diameter of at least about 3 millimeters, such as at least about 4 millimeters, at least about 5 millimeters, at least about 6 millimeters, at least about 7 millimeters, at least about 8 millimeters, at least about 9 millimeters, at least about 10 millimeters, at least about 12 millimeters, at least about 15 millimeters, at least about 20 millimeters, or even at least about 25 millimeters. Further, in some embodiments, the tube 306 may comprise a length of at least about 0.50 meters, such as at least about 0.75 meters, at least about 1 meter, at least about 1.5 meters, at least about 2 meters, at least about 3 meters, at least about 4 meters, at least about 5 meters, or even at least about 10 meters.

In the embodiment shown, the pressure device 308 comprises a selectively rotatable splined shaft assembly. The splined shaft assembly may be configured to be at least partially received within the rigid tank 302. In some embodiments, the splined shaft assembly may generally comprise an outer splined shaft 309 and an inner shaft 310 received within the outer splined shaft 309. The outer splined shaft 309 may comprise splines on one or more ends of the outer splined shaft that are configured to interface and/or interact with complementary splines 311 on an inner surface of the rigid tank 302 to selectively pressurize the flexible reservoir 304. The inner shaft 310 may extend beyond the outer footprint of the rigid tank 302, such that at least a portion of the inner shaft is received within slots 303 of the rigid tank 202 to align, level, and/or otherwise properly locate the splined shaft assembly with the rigid tank 302. In some embodiments, components of the splined shaft assembly may be formed from a metal, metal alloy, plastic, or any other material. The splined shaft assembly may generally be configured such that at least a portion of the flexible reservoir 304 is received between the outer splined shaft 309 and the inner shaft 310, whereby rotation of the splined shaft assembly in a first direction increases the pressure imparted by the pressure device 308 to the flexible reservoir 304, and rotation of the splined shaft assembly in a second opposing direction relieves the pressure imparted by the pressure device 308 to the flexible reservoir 304. However, in some embodiments, the pressure device 308 may not provide adequate pressure to discharge the fluid from the hand held spraying device 102.

Accordingly, in some embodiments, the pressure device 308 may provide at least 1 meter of H₂O pressure (about 1.42 pounds per square inch), such as at least 1.5 meters of H₂O pressure (about 2.13 pounds per square inch), at least 2 meters of H₂O pressure (about 2.84 pounds per square inch), at least 3 meters of H₂O pressure (about 4.27 pounds per square inch), at least 4 meters of H₂O pressure (about 5.69 pounds per square inch), at least 5 meters of H₂O pressure (about 7.11 pounds per square inch), or at least 10 meters of H₂O pressure (about 14.22 pounds per square inch). In some embodiments, the pressure device 308 may provide not greater than 70.31 meters of H₂O pressure (about 100 pounds per square inch), such as not greater than 42.18 meters of H₂O pressure (about 60 pounds per square inch), not greater than 31.64 meters of H₂O pressure (about 45 pounds per square inch), not greater than 28.12 meters of H₂O pressure (40 pounds per square inch), not greater than 24.61 meters of H₂O pressure (30 pounds per square inch), not greater than 17.58 meters of H₂O pressure (25 pounds per square inch), or not greater than 14.06 meters of H₂O pressure (20 pounds per square inch). It will be appreciated that the pressure device 308 may provide pressure between any of these minimum and maximum values.

Additionally, while not shown, the flexible reservoir 304 and/or the pressure device 308 may also comprise a pressure gauge, pressure regulator, a pressure relief valve, or a combination thereof. The pressure gauge, pressure regulator, pressure relief valve, or combination thereof may generally assist the user 110 in maintaining proper pressure in the flexible reservoir 304 and/or controlling the flow of a fluid from the flexible reservoir 304 to the hand held spray device 102.

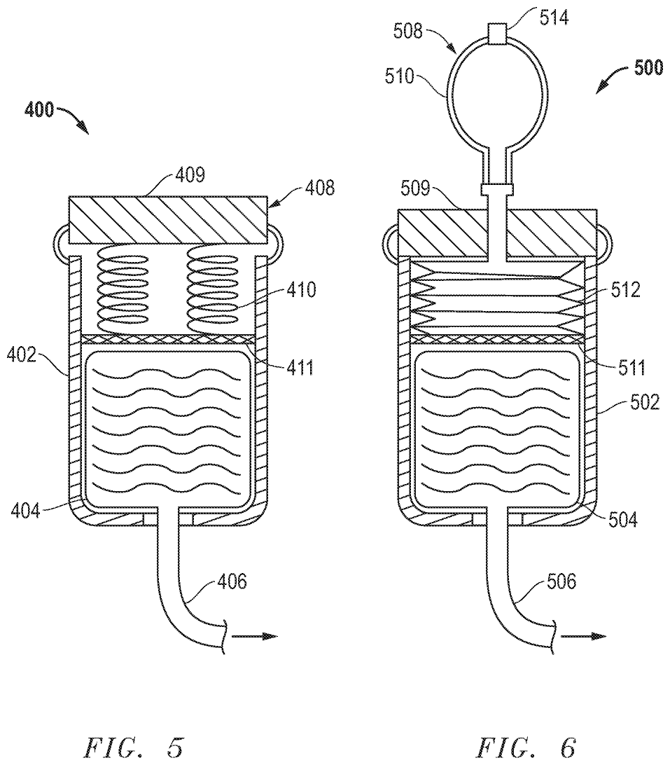

FIG. 5 shows a cross-sectional front view of a reservoir assembly 400 according to an embodiment of the disclosure. The reservoir assembly 400 may generally be substantially similar to reservoir assemblies 200, 300 in that the reservoir assembly 400 comprises a rigid tank 402, a flexible reservoir 404 received within the rigid tank 402, a tube 406 connecting the flexible reservoir 404 in fluid communication with a hand held spraying device 102, and a pressure device 408. However, in the embodiment shown, the pressure device 408 comprises at least one spring 410 configured to bias at least one of the flexible reservoir 404 and a plate 411 away from a cover 409 of the rigid tank 402 to impart pressure to the flexible reservoir 404. The reservoir assembly 400 may generally be configured to be worn by a user 110 in a substantially similar manner to reservoir assemblies 104, 200, 300. Accordingly, it will be appreciated that the rigid tank 402 may comprise appropriate bands, belts, cuffs, straps, and/or other mounting devices that securely attach the reservoir assembly 400 to the user 110. In some embodiments, the rigid tank 402 may be formed from a thermoplastic or thermosetting material (e.g., polyethylene).

In some embodiments, the flexible reservoir 404 may substantially similar to flexible reservoirs 204, 304 and be received within and be removable from the rigid tank 402.

Accordingly, in some embodiments, the rigid tank 402 may be configured to receive various sized flexible reservoirs 402. The flexible reservoir 404 may generally be formed from a pliable material, such as low-density polyethylene (LDPE). As such, an internal volume of the flexible reservoir 404 may be selectively adjustable by the pressure device 408 as fluid is discharged from the flexible reservoir 404. The flexible reservoir 404 may generally be configured to carry a volume of fluid (e.g., lacquer, paint, stain, or other cosmetic enhancing fluid) until the fluid is discharged through the hand held spraying device 102. In some embodiments, the flexible reservoir 404 may comprise a volume of at least about 150 cubic centimeters, such as at least about 200 cubic centimeters, at least about 250 cubic centimeters, at least about 300 cubic centimeters, at least about 350 cubic centimeters, at least about 500 cubic centimeters, at least about 750 cubic centimeters, or at least about 1000 cubic centimeters, at least about 1500 cubic centimeters, at least about 2000 cubic centimeters, or even at least about 2500 cubic centimeters. Furthermore, in some embodiments, the flexible reservoir 404 may be sealable and/or resealable.

The tube 406 may generally be substantially similar to the tubes 206, 306 and connect the flexible reservoir 404 in fluid communication with the hand held spraying device 102. More specifically, the tube 406 may connect the flexible reservoir 404 in fluid communication with the second inlet 122 of the hand held spray device 102. In some embodiments, the tube 406 may comprise an inner diameter of at least about 3 millimeters, such as at least about 4 millimeters, at least about 5 millimeters, at least about 6 millimeters, at least about 7 millimeters, at least about 8 millimeters, at least about 9 millimeters, at least about 10 millimeters, at least about 12 millimeters, at least about 15 millimeters, at least about 20 millimeters, or even at least about 25 millimeters. Further, in some embodiments, the tube 406 may comprise a length of at least about 0.50 meters, such as at least about 0.75 meters, at least about 1 meter, at least about 1.5 meters, at least about 2 meters, at least about 3 meters, at least about 4 meters, at least about 5 meters, or even at least about 10 meters.

In the embodiment shown, the pressure device 408 comprises at least one spring 410 configured to bias at least one of the flexible reservoir 404 and a plate 411 in contact with the flexible reservoir 404 away from a cover 409 of the rigid tank 402 to impart pressure to the flexible reservoir 404. The cover 409 may be configured to be selectively securable to the rigid tank 302, and the at least one spring 410 and the plate 409 may be received within the rigid tank 402. In some embodiments, the cover 409 may be threaded onto the rigid tank 402. In other embodiments, the cover 409 may be secured to the rigid tank 402 by mechanical clips, fasteners, or the like. In some embodiments, when the cover 409 is secured to the rigid tank 402, the at least one spring 410 may bias the plate 411 away from the cover 409 to impart pressure to the flexible reservoir 404. However, in some embodiments, the pressure device 408 may not comprise a plate 411, such that the at least one spring 410 biases directly against the flexible reservoir 404. Accordingly, it will be appreciated that the length and/or the spring rate of the at least one spring 410 may be selected in order to impart a predetermined pressure to the flexible reservoir 404 to move fluid from the internal volume of the flexible reservoir 404, through the tube 406, and to the hand held spraying device 102. However, in some embodiments, the pressure device 408 may not provide adequate pressure to discharge the fluid from the hand held spraying device 102. Accordingly, in some embodiments, the pressure device 408 may provide at least 1 meter of H₂O pressure (about 1.42 pounds per square inch), such as at least 1.5 meters of H₂O pressure (about 2.13 pounds per square inch), at least 2 meters of H₂O pressure (about 2.84 pounds per square inch), at least 3 meters of H₂O pressure (about 4.27 pounds per square inch), at least 4 meters of H₂O pressure (about 5.69 pounds per square inch), at least 5 meters of H₂O pressure (about 7.11 pounds per square inch), or at least 10 meters of H₂O pressure (about 14.22 pounds per square inch). In some embodiments, the pressure device 408 may provide not greater than 70.31 meters of H₂O pressure (about 100 pounds per square inch), such as not greater than 42.18 meters of H₂O pressure (about 60 pounds per square inch), not greater than 31.64 meters of H₂O pressure (about 45 pounds per square inch), not greater than 28.12 meters of H₂O pressure (40 pounds per square inch), not greater than 24.61 meters of H₂O pressure (30 pounds per square inch), not greater than 17.58 meters of H₂O pressure (25 pounds per square inch), or not greater than 14.06 meters of H₂O pressure (20 pounds per square inch). It will be appreciated that the pressure device 408 may provide pressure between any of these minimum and maximum values.

Additionally, while not shown, the flexible reservoir 404 and/or the pressure device 408 may also comprise a pressure gauge, pressure regulator, a pressure relief valve, or a combination thereof. The pressure gauge, pressure regulator, pressure relief valve, or combination thereof may generally assist the user 110 in maintaining proper pressure in the flexible reservoir 404 and/or controlling the flow of a fluid from the flexible reservoir 404 to the hand held spray device 102.

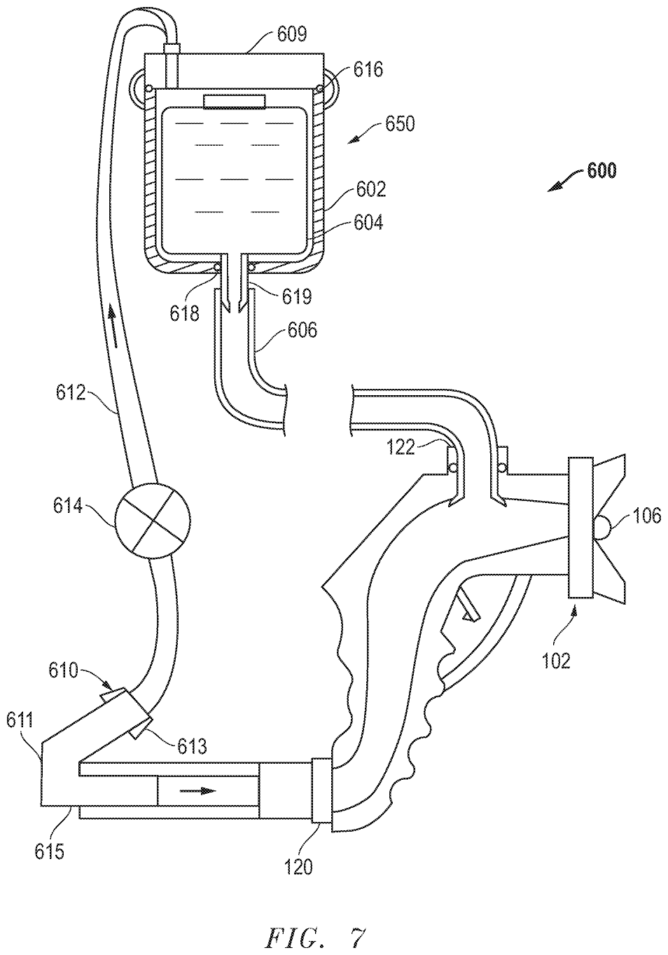

FIG. 6 is a cross-sectional front view of a reservoir assembly 500 according to another embodiment of the disclosure. The reservoir assembly 500 may generally be substantially similar to reservoir assemblies 200, 300, 400 in that the reservoir assembly 500 comprises a rigid tank 502, a flexible reservoir 504 received within the rigid tank 502, a tube 506 connecting the flexible reservoir 504 in fluid communication with a hand held spraying device 102, and a pressure device 508. However, in the embodiment shown, the pressure device 508 comprises a manual pump 510 and an inflatable diaphragm 512 coupled to the manual pump 510. The reservoir assembly 500 may generally be configured to be worn by a user 110 in a substantially similar manner to reservoir assemblies 104, 200, 300, 400. Accordingly, it will be appreciated that the rigid tank 502 may comprise appropriate bands, belts, cuffs, straps, and/or other mounting devices that securely attach the reservoir assembly 500 to the user 110. In some embodiments, the rigid tank 502 may be formed from a thermoplastic or thermosetting material (e.g., polyethylene).

In some embodiments, the flexible reservoir 504 may substantially similar to flexible reservoirs 204, 304, 404 and be received within and be removable from the rigid tank 502. Accordingly, in some embodiments, the rigid tank 502 may be configured to receive various sized flexible reservoirs 502. The flexible reservoir 504 may generally be formed from a pliable material, such as low-density polyethylene (LDPE). As such, an internal volume of the flexible reservoir 504 may be selectively adjustable by the pressure device 508 as fluid is discharged from the flexible reservoir 504. The flexible reservoir 504 may generally be configured to carry a volume of fluid (e.g., lacquer, paint, stain, or other cosmetic enhancing fluid) until the fluid is discharged through the hand held spraying device 102. In some embodiments, the flexible reservoir 504 may comprise a volume of at least about 150 cubic centimeters, such as at least about 200 cubic centimeters, at least about 250 cubic centimeters, at least about 300 cubic centimeters, at least about 350 cubic centimeters, at least about 500 cubic centimeters, at least about 750 cubic centimeters, or at least about 1000 cubic centimeters, at least about 1500 cubic centimeters, at least about 2000 cubic centimeters, or even at least about 2500 cubic centimeters. Furthermore, in some embodiments, the flexible reservoir 504 may be sealable and/or resealable.

The tube 506 may generally be substantially similar to the tubes 206, 306, 406 and connect the flexible reservoir 504 in fluid communication with the hand held spraying device 102. More specifically, the tube 506 may connect the flexible reservoir 504 in fluid communication with the second inlet 122 of the hand held spray device 102. In some embodiments, the tube 506 may comprise an inner diameter of at least about 3 millimeters, such as at least about 4 millimeters, at least about 5 millimeters, at least about 6 millimeters, at least about 7 millimeters, at least about 8 millimeters, at least about 9 millimeters, at least about 10 millimeters, at least about 12 millimeters, at least about 15 millimeters, at least about 20 millimeters, or even at least about 25 millimeters. Further, in some embodiments, the tube 506 may comprise a length of at least about 0.50 meters, such as at least about 0.75 meters, at least about 1 meter, at least about 1.5 meters, at least about 2 meters, at least about 3 meters, at least about 4 meters, at least about 5 meters, or even at least about 10 meters.

In the embodiment shown, the pressure device 508 comprises a manual pump 510 and an inflatable diaphragm 512 coupled to the manual pump 510. The cover 509 may be configured to be selectively securable to the rigid tank 502. The manual pump 510 may be carried by and/or mounted to the cover 509, and the inflatable diaphragm 512 may be received within the rigid tank 502. In some embodiments, the cover 509 may be threaded onto the rigid tank 502. In other embodiments, the cover 509 may be secured to the rigid tank 502 by mechanical clips, fasteners, or the like. In some embodiments, when the cover 509 is secured to the rigid tank 502, the manual pump 510 may be selectively operated by a user 110 to inflate the inflatable diaphragm 512. In some embodiments, inflation of the inflatable diaphragm 512 may generally bias the inflatable diaphragm 512 away from a cover 509 of the rigid tank 502 and against a plate 511 to impart pressure to the flexible reservoir 504. However, in some embodiments, the pressure device 508 may not comprise a plate 511, such that inflation of the inflatable diaphragm 512 biases directly against the flexible reservoir 504. Accordingly, it will be appreciated that the contracted and/or expanded volume of the inflatable diaphragm 512 may be selected in order to impart a predetermined pressure to the flexible reservoir 504 to move fluid from the internal volume of the flexible reservoir 504, through the tube 506, and to the hand held spraying device 102. However, in some embodiments, the pressure device 508 may not provide adequate pressure to discharge the fluid from the hand held spraying device 102.

Accordingly, in some embodiments, the pressure device 508 may provide at least 1 meter of H₂O pressure (about 1.42 pounds per square inch), such as at least 1.5 meters of H₂O pressure (about 2.13 pounds per square inch), at least 2 meters of H₂O pressure (about 2.84 pounds per square inch), at least 3 meters of H₂O pressure (about 4.27 pounds per square inch), at least 4 meters of H₂O pressure (about 5.69 pounds per square inch), at least 5 meters of H₂O pressure (about 7.11 pounds per square inch), or at least 10 meters of H₂O pressure (about 14.22 pounds per square inch). In some embodiments, the pressure device 508 may provide not greater than 70.31 meters of H₂O pressure (about 100 pounds per square inch), such as not greater than 42.18 meters of H₂O pressure (about 60 pounds per square inch), not greater than 31.64 meters of H₂O pressure (about 45 pounds per square inch), not greater than 28.12 meters of H₂O pressure (40 pounds per square inch), not greater than 24.61 meters of H₂O pressure (30 pounds per square inch), not greater than 17.58 meters of H₂O pressure (25 pounds per square inch), or not greater than 14.06 meters of H₂O pressure (20 pounds per square inch). It will be appreciated that the pressure device 508 may provide pressure between any of these minimum and maximum values.

Additionally, while not shown, the flexible reservoir 504, the pressure device 508, and/or the manual pump 510 may also comprise a pressure gauge, pressure regulator, a pressure relief valve 514, or a combination thereof. The pressure gauge, pressure regulator, pressure relief valve 514, or combination thereof may generally assist the user 110 in maintaining proper pressure in the flexible reservoir 504 and/or controlling the flow of a fluid from the flexible reservoir 504 to the hand held spray device 102.

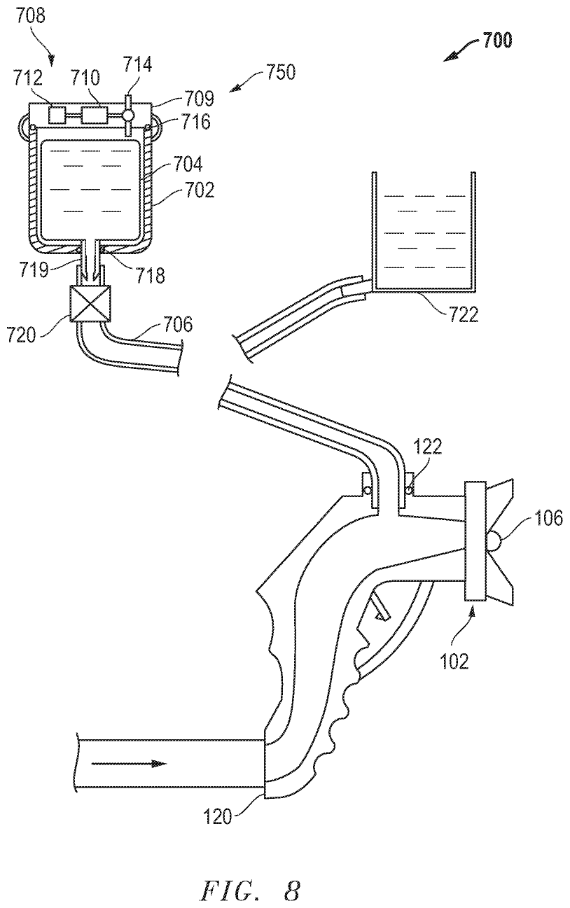

FIG. 7 is a schematic side view of a spraying apparatus 600 according to an alternative embodiment of the disclosure. The spraying apparatus 600 may generally comprise a hand held spraying device 102 and a reservoir assembly 650. The reservoir assembly 650 may generally be substantially similar to reservoir assemblies 200, 300, 400, 500 in that the reservoir assembly 650 comprises a rigid tank 602, a flexible reservoir 604 received within the rigid tank 602, a tube 606 connecting the flexible reservoir 604 in fluid communication with the hand held spraying device 102, and a pressure device 608. However, in the embodiment shown, the pressure device 608 comprises a Y-adapter 610 comprising an inlet 611 connected to a pressure source (e.g., air compressor as known in the art), a first branch or outlet 613 connected to the rigid tank 502 or the flexible reservoir 604 through a tube 612, and a second branch or outlet 615 connected to the first inlet 120 of the hand held spraying device 102. Additionally, in some embodiments, the pressure device 608 may also comprise a pressure regulator 614 disposed between the first branch 613 of the Y-adapter 610 and the flexible reservoir 604. As such, the pressure regulator 614 may allow a user 100 to control, manage, or otherwise manipulate the pressure applied to or in the flexible reservoir 604.

In some embodiments, the pressure regulator 614 may be adapted to control pressures between about 0 pounds per square inch and about 120 pounds per square inch. However, in some embodiments, the pressure regulator 614 may provide at least 1 meter of H₂O pressure (about 1.42 pounds per square inch), such as at least 1.5 meters of H₂O pressure (about 2.13 pounds per square inch), at least 2 meters of H₂O pressure (about 2.84 pounds per square inch), at least 3 meters H₂O pressure (about 4.27 pounds per square inch), at least 4 meters of H₂O pressure (about 5.69 pounds per square inch), at least 5 meters of H₂O pressure (about 7.11 pounds per square inch), or at least 10 meters of H₂O pressure (about 14.22 pounds per square inch) to the flexible reservoir 604. In some embodiments, the pressure regulator 614 may provide not greater than 70.31 meters of H₂O pressure (about 100 pounds per square inch), such as not greater than 42.18 meters of H₂O pressure (about 60 pounds per square inch), not greater than 31.64 meters of H₂O pressure (about 45 pounds per square inch), not greater than 28.12 meters of H₂O pressure (40 pounds per square inch), not greater than 24.61 meters of H₂O pressure (30 pounds per square inch), not greater than 17.58 meters of H₂O pressure (25 pounds per square inch), or not greater than 14.06 meters of H₂O pressure (20 pounds per square inch) to the flexible reservoir 604. It will be appreciated that the pressure regulator 614 may provide pressure to the flexible reservoir 604 between any of these minimum and maximum values. Further, in some embodiments, it will be appreciated that the pressure provided to the flexible reservoir 604 may be less than the pressure provided to the hand held spraying device 102.

The reservoir assembly 650 may generally be configured to be worn by a user 110 in a substantially similar manner to reservoir assemblies 104, 200, 300, 400, 500. Accordingly, it will be appreciated that the rigid tank 602 may comprise appropriate bands, belts, cuffs, straps, and/or other mounting devices that securely attach the reservoir assembly 650 to the user 110. In some embodiments, the rigid tank 602 may be formed from a thermoplastic or thermosetting material (e.g., polyethylene). In some embodiments, the rigid tank 602 may comprise a cover 609 configured to be selectively securable to the rigid tank 602. A gasket or seal (e.g., O-ring) 616 may be disposed between the rigid tank 602 and the cover 609 to provide an airtight fluid seal between the rigid tank 602 and the cover 609. In some embodiments, the cover 609 may be threaded onto the rigid tank 602. In other embodiments, the cover 609 may be secured to the rigid tank 602 by mechanical clips, fasteners, or the like. Further, in some embodiments, the rigid tank 602 may also comprise a gasket or seal (e.g., O-ring, etc.) 618 to provide an airtight fluid seal between an outlet 619 of the flexible reservoir 504 and the rigid tank 602.

In some embodiments, the flexible reservoir 604 may substantially similar to flexible reservoirs 204, 304, 404, 504 and be received within and be removable from the rigid tank 602. Accordingly, in some embodiments, the rigid tank 602 may be configured to receive various sized flexible reservoirs 602. The flexible reservoir 604 may generally be formed from a pliable material, such as low-density polyethylene (LDPE). The flexible reservoir 604 may generally be configured to carry a volume of fluid (e.g., lacquer, paint, stain, or other cosmetic enhancing fluid) until the fluid is discharged through the nozzle 106 of the hand held spraying device 102. In some embodiments, the flexible reservoir 604 may comprise a volume of at least about 150 cubic centimeters, such as at least about 200 cubic centimeters, at least about 250 cubic centimeters, at least about 300 cubic centimeters, at least about 350 cubic centimeters, at least about 500 cubic centimeters, at least about 750 cubic centimeters, or at least about 1000 cubic centimeters, at least about 1500 cubic centimeters, at least about 2000 cubic centimeters, or even at least about 2500 cubic centimeters. In some embodiments, the flexible reservoir 604 may be sealable and/or resealable.

The tube 606 may generally be substantially similar to the tubes 206, 306, 406, 506 and connect the flexible reservoir 604 in fluid communication with the hand held spraying device 102. More specifically, the tube 606 may connect the outlet 619 of the flexible reservoir 604 in fluid communication with the second inlet 122 of the hand held spray device 102. In some embodiments, the tube 606 may comprise an inner diameter of at least about 3 millimeters, such as at least about 4 millimeters, at least about 5 millimeters, at least about 6 millimeters, at least about 7 millimeters, at least about 8 millimeters, at least about 9 millimeters, at least about 10 millimeters, at least about 12 millimeters, at least about 15 millimeters, at least about 20 millimeters, or even at least about 25 millimeters. Further, in some embodiments, the tube 606 may comprise a length of at least about 0.50 meters, such as at least about 0.75 meters, at least about 1 meter, at least about 1.5 meters, at least about 2 meters, at least about 3 meters, at least about 4 meters, at least about 5 meters, or even at least about 10 meters.

In the embodiment shown, the pressure device 608 comprises a Y-adapter 610 comprising an inlet 611 connected to a pressure source (e.g., air compressor as known in the art), a first branch or outlet 613 connected to the rigid tank 502 or the flexible reservoir 604 through a tube 612, and a second branch or outlet 615 connected to the first inlet 120 of the hand held spraying device 102. In some embodiments, the gaskets or seals 616, 618 may form an airtight fluid seal between the rigid tank 502 and each of the cover 609 and the outlet 619 of the flexible reservoir 604. As such, when the tube 612 is coupled to the rigid tank (or cover 609 of the rigid tank 602), pressure from the pressure device 608 may pressurize an internal volume of the rigid tank 602. Since the flexible reservoir 604 is carried within the internal volume of the rigid tank 602, pressure applied to the rigid tank 602 by the pressure device 608 may impart pressure to the flexible reservoir 604 to move fluid from the internal volume of the flexible reservoir 604, through the tube 606, and to the hand held spraying device 102. However, in other embodiments, the tube 612 may be directly connected to the flexible reservoir 604. As such, pressure applied by the pressure device 608 may directly pressurize the flexible reservoir 604 to move fluid from the internal volume of the flexible reservoir 604, through the tube 606, and to the hand held spraying device 102.

Additionally, while not shown, the flexible reservoir 604 and/or the pressure device 608 may also comprise a pressure gauge, an additional pressure regulator, a pressure relief valve, or any combination thereof. The pressure gauge, additional pressure regulator, pressure relief valve, or combination thereof may generally assist the user 110 in maintaining proper pressure in the flexible reservoir 604 and/or controlling the flow of a fluid from the flexible reservoir 604 to the hand held spray device 102.

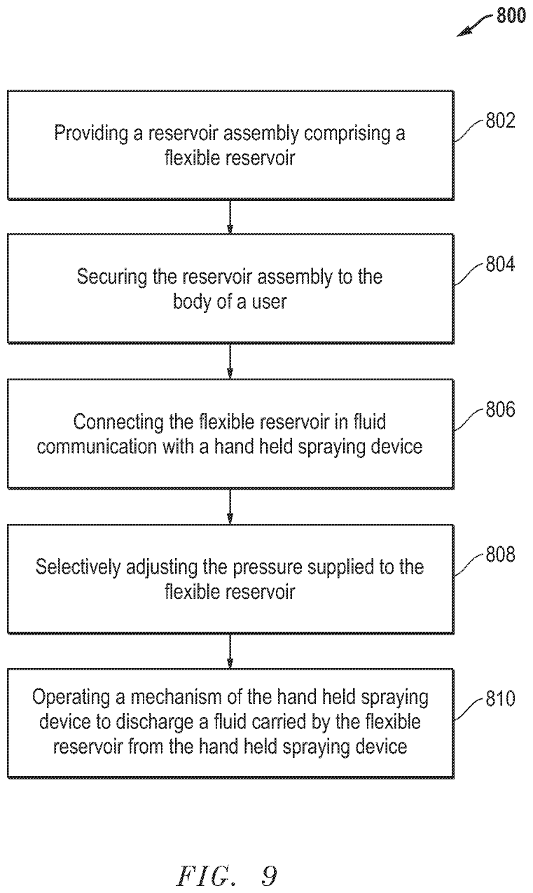

FIG. 8 is a schematic side view of a spraying apparatus 700 according to another alternative embodiment of the disclosure. The spraying apparatus 700 may generally comprise a hand held spraying device 102 and a reservoir assembly 750. The reservoir assembly 750 may generally be substantially similar to reservoir assemblies 200, 300, 400, 500, 650 in that the reservoir assembly 750 comprises a rigid tank 702, a flexible reservoir 704 received within the rigid tank 702, a tube 706 connecting the flexible reservoir 704 in fluid communication with the hand held spraying device 102, and a pressure device 708. However, in the embodiment shown, the pressure device 708 comprises a fluid pump 710 that may provide pressure to the rigid tank 702, which is then imparted to the flexible reservoir 704, or alternatively, directly to the flexible reservoir 704.

The pump 710 may generally be carried by a cover 709 of the rigid tank 702, or alternatively, by the rigid tank 702 itself. In some embodiments, the pump 710 may comprise a micropump. In some embodiments, the micropump may be operable at 6 VDC and/or 12 VDC. In some embodiments, the micropump may be operable between 0 millibar (0 pounds per square inch) and 300 millibar (4.35 pounds per square inch) and operable to provide a flow rate of at least about 2.5 Liters per minute. However, in some embodiments, the working pressure of the micropump may comprise at least about 100 millibar (1.45 pounds per square inch), such as at least about 110 millibar (1.59 pounds per square inch), or even at least about 120 millibar (1.74 pounds per square inch). In some embodiments, the working pressure of the micropump may be not greater than about 220 millibar (3.19 pounds per square inch), such as not greater than about 210 millibar (3.05 pounds per square inch), or even not greater than about 200 millibar (2.90 pounds per square inch). It will be appreciated that the pressure of the micropump may between any of these minimum and maximum values, such as at least about 120 millibar to not greater than about 200 millibar.

Additionally, in some embodiments, the pressure device 708 may also comprise a battery 712 configured to provide power to the pump 710. The battery 712 may generally be carried by the cover 709 of the rigid tank 702, or alternatively, by the rigid tank 702 itself.

The battery 712 may generally comprise a rechargeable, lithium ion battery. However, in other embodiments, the battery 712 may comprise any other suitable electrical power source. It will be appreciated that the battery 712 may be selected to provide the proper voltage to the pump 710. As such, the battery 712 may be operable to provide 6 VDC and/or 12 VDC. In alternative embodiments, the pressure device 708 may comprise a plurality of batteries 712 that are wired in parallel and/or series to provide the proper voltage to the pump 710.

Further, in some embodiments, the pressure device 708 may also comprise a pressure regulator 714 configured to selectively control, regulate, or otherwise manipulate the pressure provided by the pump 710. The pressure regulator 714 may also be selectively adjustable to control the flow of fluid to the hand held spraying device 102 from the flexible reservoir 704. However, in some embodiments, the pressure device 708 may not provide adequate pressure to discharge the fluid from the hand held spraying device 102. The pressure regulator 714 may generally be carried by the cover 709 of the rigid tank 702, or alternatively, by the rigid tank 702 itself. At least in some embodiments, the pressure regulator 714 may also enable the pump 710 to initiate operation and turn on or off at a predetermined pressure. Accordingly, it will be appreciated that the pump 710, the battery 712, and the pressure regulator 714 may be carried by the rigid tank 702. However, in some embodiments, the pump 710, the battery 712, and the pressure regulator 714 may be carried by the cover 709 of the rigid tank 702.

In some embodiments, the pressure regulator 714 may be adapted to control pressures between about 0 pounds per square inch and about 120 pounds per square inch. However, in some embodiments, the pressure regulator 714 may provide at least 1 meter of H₂O pressure (about 1.42 pounds per square inch), such as at least 1.5 meters of H₂O pressure (about 2.13 pounds per square inch), at least 2 meters of H₂O pressure (about 2.84 pounds per square inch), at least 3 meters of H₂O pressure (about 4.27 pounds per square inch), at least 4 meters of H₂O pressure (about 5.69 pounds per square inch), at least 5 meters of H₂O pressure (about 7.11 pounds per square inch), or at least 10 meters of H₂O pressure (about 14.22 pounds per square inch) to the flexible reservoir 704. In some embodiments, the pressure regulator 714 may provide not greater than 70.31 meters of H₂O pressure (about 100 pounds per square inch), such as not greater than 42.18 meters of H₂O pressure (about 60 pounds per square inch), not greater than 31.64 meters of H₂O pressure (about 45 pounds per square inch), not greater than 28.12 meters of H₂O pressure (40 pounds per square inch), not greater than 24.61 meters of H₂O pressure (30 pounds per square inch), not greater than 17.58 meters of H₂O pressure (25 pounds per square inch), or not greater than 14.06 meters of H₂O pressure (20 pounds per square inch) to the flexible reservoir 704. It will be appreciated that the pressure regulator 714 may provide pressure to the flexible reservoir 704 between any of these minimum and maximum values. Furthermore, in some embodiments, it will be appreciated that the pressure provided to the flexible reservoir 704 may be less than the pressure provided to the hand held spraying device 102.

The reservoir assembly 750 may generally be configured to be worn by a user 110 in a substantially similar manner to reservoir assemblies 104, 200, 300, 400, 500, 650. Accordingly, it will be appreciated that the rigid tank 702 may comprise appropriate bands, belts, cuffs, straps, and/or other mounting devices that securely attach the reservoir assembly 750 to the user 110. In some embodiments, the rigid tank 702 may be formed from a thermoplastic or thermosetting material (e.g., polyethylene). In some embodiments, the rigid tank 702 may comprise a cover 709 configured to be selectively securable to the rigid tank 702. A gasket or seal (e.g., O-ring) 716 may be disposed between the rigid tank 702 and the cover 709 to provide an airtight fluid seal between the rigid tank 702 and the cover 709. In some embodiments, the cover 709 may be threaded onto the rigid tank 702. In other embodiments, the cover 709 may be secured to the rigid tank 702 by mechanical clips, fasteners, or the like. Further, in some embodiments, the rigid tank 702 may also comprise a gasket or seal (e.g., O-ring, etc.) 718 to provide an airtight fluid seal between a tube connector or outlet 719 of the flexible reservoir 704 and the rigid tank 702. As stated, it will be appreciated that the pump 710, the battery 712, and the pressure regulator 714 may be carried by the rigid tank 702. However, in some embodiments, the pump 710, the battery 712, and the pressure regulator 714 may be carried by the cover 709 of the rigid tank 702. Further, in some embodiments, the cover 709 may be removable and configured to be placed on an external charging base to charge the battery 712.

In some embodiments, the flexible reservoir 704 may substantially similar to flexible reservoirs 204, 304, 404, 504, 604 and be received within and be removable from the rigid tank 702. Accordingly, in some embodiments, the rigid tank 702 may be configured to receive various sized flexible reservoirs 702. The flexible reservoir 704 may generally be formed from a pliable material, such as low-density polyethylene (LDPE). The flexible reservoir 704 may generally be configured to carry a volume of fluid (e.g., lacquer, paint, stain, or other cosmetic enhancing fluid) until the fluid is discharged through the nozzle 106 of the hand held spraying device 102. In some embodiments, the flexible reservoir 704 may comprise a volume of at least about 150 cubic centimeters, such as at least about 200 cubic centimeters, at least about 250 cubic centimeters, at least about 300 cubic centimeters, at least about 350 cubic centimeters, at least about 500 cubic centimeters, at least about 750 cubic centimeters, or at least about 1000 cubic centimeters, at least about 1500 cubic centimeters, at least about 2000 cubic centimeters, or even at least about 2500 cubic centimeters. In some embodiments, the flexible reservoir 704 may be sealable and/or resealable. The tube 706 may generally be substantially similar to the tubes 206, 306, 406, 506, 606 and connect the flexible reservoir 704 in fluid communication with the hand held spraying device 102. More specifically, the tube 706 may connect an outlet 719 of the flexible reservoir 704 in fluid communication with the second inlet 122 of the hand held spray device 102. In some embodiments, the tube 706 may comprise an inner diameter of at least about 3 millimeters, such as at least about 4 millimeters, at least about 5 millimeters, at least about 6 millimeters, at least about 7 millimeters, at least about 8 millimeters, at least about 9 millimeters, at least about 10 millimeters, at least about 12 millimeters, at least about 15 millimeters, at least about 20 millimeters, or even at least about 25 millimeters. Further, in some embodiments, the tube 706 may comprise a length of at least about 0.50 meters, such as at least about 0.75 meters, at least about 1 meter, at least about 1.5 meters, at least about 2 meters, at least about 3 meters, at least about 4 meters, at least about 5 meters, or even at least about 10 meters.

In some embodiments, the tube 706 may be configured to be disconnected from the hand held spraying device 102 and connected to a mixing apparatus 722. Additionally, in some embodiments, the tube 706 may comprise a valve 720 configured to selectively restrict the flow or fluid through the tube 706. As such, the valve 720 may be closed prior to disconnecting the tube 706 from the hand held spraying device 102 to prevent the spilling of fluid from the flexible reservoir 704. Once the tube 706 is disconnected from the hand held spraying device 102 and connected to the mixing apparatus 720, the valve 720 may be selectively opened. The pump 710 may be reversible such that the pump 710 may draw fluid from the mixing apparatus 722, through the tube 706, and into the flexible reservoir 704. Thus, manual steps of pouring mixed paint or other surface enhancing liquids into a reservoir of a hand held spray device 102 may be eliminated and fully automated by the reservoir assembly 750.

In the embodiment shown, the pressure device 708 comprises a pump 710 that may pressurize the rigid tank 702, which is then imparted to the flexible reservoir 704, or alternatively, directly pressurize the flexible reservoir 704. In some embodiments, the gaskets or seals 716, 718 may form an airtight fluid seal between the rigid tank 502 and each of the cover 709 and the outlet 719 of the flexible reservoir 704. As such, in some embodiments, pressure generated by the pump 710 may pressurize an internal volume of the rigid tank 602. Since the flexible reservoir 704 is carried within the internal volume of the rigid tank 702, pressure applied to the rigid tank 702 by the pump 710 may impart pressure to the flexible reservoir 704 to move fluid from the internal volume of the flexible reservoir 704, through the tube 706, and to the hand held spraying device 102. However, in other embodiments, the pump 710 may be coupled directly to the flexible reservoir 704 and directly pressurize the flexible reservoir 604 to move fluid from the internal volume of the flexible reservoir 604, through the tube 606, and to the hand held spraying device 102. Further, the hand held spraying device 102 may generally be connected to an external pressure source (e.g., air compressor, etc.) and be configured to spray the fluid received from the flexible reservoir 704 in response to the user selectively operating a mechanism 118 of the hand held spraying device 102.

Additionally, while not shown, the flexible reservoir 704 and/or the pressure device 708 may also comprise a pressure gauge, an additional pressure regulator, a pressure relief valve, or any combination thereof. The pressure gauge, additional pressure regulator, pressure relief valve, or combination thereof may generally assist the user 110 in maintaining proper pressure in the flexible reservoir 704 and/or controlling the flow of a fluid from the flexible reservoir 704 to the hand held spray device 102.

Embodiments of a spraying apparatus 100, 600, 700 are disclosed herein. It will be appreciated that a spraying apparatus 100, 600, 700 may include the hand held spraying device 102 and any of the reservoir assembles 104, 200, 300, 400, 500, 650, 750 disclosed herein. Accordingly, it will be appreciated that any of the reservoir assemblies 200, 300, 400, 500, 650, 750 disclosed herein may be substituted for the reservoir assembly 104 of FIG. 1 to form a spraying apparatus contemplated by this disclosure, and which may operated by the following method(s).

Furthermore, it will be appreciated that embodiments of the spraying apparatus 100, 600, 700 may be referred to as a dual pressure spraying apparatus, where a first pressure is supplied by one of the pressure devices 108, 208, 308, 408, 508, 608, 708 to force fluid from the associated flexible reservoir 104, 204, 304, 404, 504, 604, 704 to the hand held spraying device 102, and where a second pressure is supplied by an external pressure source (e.g., air compressor) to the first inlet 120 of the hand held spraying device 102 to discharge the fluid through the nozzle 106 of the hand held spraying device 102. It will be appreciated that in some embodiments, the first pressure (or, alternatively, each pressure in a range of first pressures) may be less than the second pressure (or, alternatively, each pressure in a range of second pressures), such that the lower first pressure drives the fluid to the hand held spraying device 102 and the higher second pressure is sufficient to discharge the fluid from the nozzle 106 of the hand held spraying device 102 in response to actuation, manipulation, and/or operation of the mechanism 118 of the hand held spraying device 102. As such, in some embodiments, the first pressure may be not greater than the second pressure. However, in some embodiments, the first pressure may be not greater than 95% of the second pressure, such as not greater than 90% of the second pressure, not greater than 85% of the second pressure, not greater than 80% of the second pressure, not greater than 75% of the second pressure, not greater than 70% of the second pressure, not greater than 65% of the second pressure, not greater than 60% of the second pressure, not greater than 55% of the second pressure, not greater than 50% of the second pressure, not greater than 45% of the second pressure, not greater than 40% of the second pressure, not greater than 35% of the second pressure, not greater than 30% of the second pressure, not greater than 25% of the second pressure, not greater than 20% of the second pressure, not greater than 15% of the second pressure, not greater than 10% of the second pressure, not greater than 5% of the second pressure, not greater than 4% of the second pressure, not greater than 3% of the second pressure, not greater than 2% of the second pressure, or not greater than 1% of the second pressure. For example, in some embodiments, a pressure device 108, 208, 308, 408, 508, 608, 708 may supply a first pressure of 1.5 meters of H₂O pressure (about 2.13 pounds per square inch), and the external pressure source may supply a second pressure of about 60 pounds per square inch.

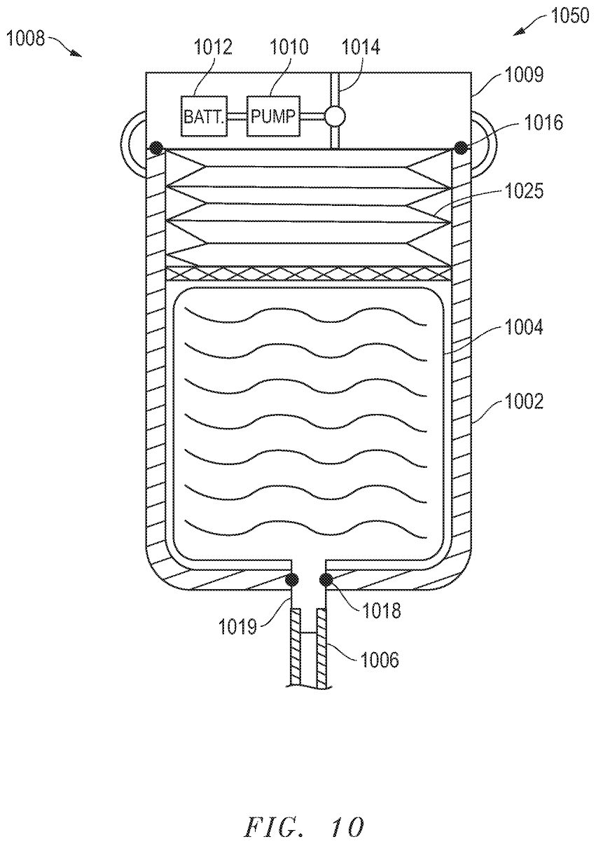

FIG. 9 is a flowchart of a method 800 of operating a spraying apparatus 100, 600, 700 according to an embodiment of the disclosure. Method 800 begins at block 802 by providing a reservoir assembly 104, 200, 300, 400, 500, 650, 750 comprising a flexible reservoir 104, 204, 304, 404, 504, 604, 704. Method 800 continues at block 804 by securing the reservoir assembly 100, 200, 300, 400, 500, 650, 750 to the body of a user 100. Method 800 continues at block 806 by connecting the flexible reservoir 104, 204, 304, 404, 504, 604, 704 in fluid communication with a hand held spraying device 102. In some embodiments, this may be accomplished via a tube 106, 206, 306, 406, 506, 706. Method 800 continues at block 808 by selectively adjusting the pressure supplied to the flexible reservoir 104, 204, 304, 404, 504, 604, 704. Method 800 may conclude at block 810 by operating an mechanism 118 of the hand held spraying device 102 to discharge a fluid carried by the flexible reservoir 104, 204, 304, 404, 504, 604, 704 from the hand held spraying device 102.

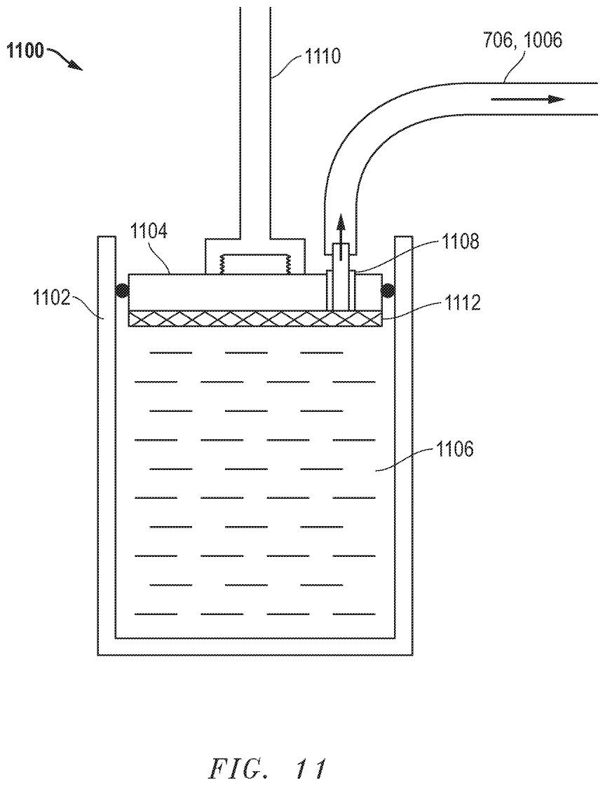

FIG. 10 is a schematic side view of a reservoir assembly 1050 according to an embodiment of the disclosure. In some embodiments, the reservoir assembly 1050 may be used in conjunction with a spraying apparatus, such as the spraying apparatus 700. The reservoir assembly 1050 may generally be substantially similar to one or more of reservoir assemblies 200, 300, 400, 500, 650, 750 in that the reservoir assembly 1050 comprises a rigid tank 1002, a flexible reservoir 1004 received within the rigid tank 1002, a tube 1006 connecting the flexible reservoir 1004 in fluid communication with a hand held spraying device 102, and a pressure device 1008. In a specific embodiment, the reservoir assembly 1050 may generally be substantially similar to the reservoir assembly 750. However, in the embodiment shown, the reservoir assembly 1050 comprises an inflatable diaphragm 1025. As such, the pressure device 1008 comprises a fluid pump 1010 that may provide pressure to the rigid tank 1002 via the inflatable diaphragm 512 that is coupled to the fluid pump 1010. The pressure that inflates the inflatable diaphragm 1025 may then be imparted to the flexible reservoir 1004. In some embodiments, the inflatable diaphragm 1025 may be substantially similar to the inflatable diaphragm 512.

Similarly to the reservoir assembly 750, the reservoir assembly 1050 may also comprise a battery 1012 and a pressure regulator 1014 carried within the cover 1009 along with the fluid pump 1010. However, in other embodiments, the battery, the fluid pump 1010, and/or the pressure regulator 1014 may be carried by the rigid tank 1002. Further, in some embodiments, the reservoir assembly 1050 may also comprise gaskets or seals 1016, 1018. The gasket or seal (e.g., O-ring) 1016 may be disposed between the rigid tank 1002 and the cover 1009 to provide an airtight fluid seal between the rigid tank 1002 and the cover 1009. The gasket or seal (e.g., O-ring, etc.) 1018 may be disposed about a tube connector or outlet 1019 of the flexible reservoir 1004 to provide an airtight fluid seal between the outlet 1019 of the flexible reservoir 1004 and the rigid tank 1002.

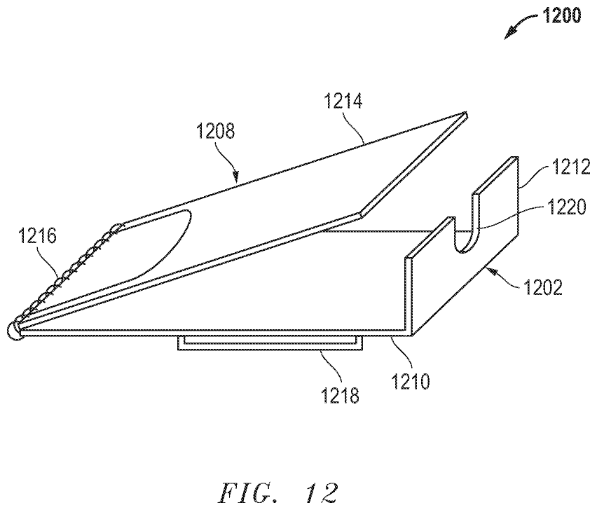

FIG. 11 is a schematic side view of a mixing apparatus 1100 according to an embodiment of the disclosure. In some embodiments, the mixing apparatus 1100 may be substantially similar to or representative of the mixing apparatus 722. The mixing apparatus 1100 may generally comprise a mixing reservoir 1102, a cover 1104 to seal an internal volume 1106 of the mixing reservoir 1102, and a tube connection 1108. In some embodiments, the mixing apparatus 1100 may also comprise a pressure mechanism 1110 configured to provide pressure to the internal volume 1106 of the mixing reservoir 1102. The pressure mechanism 1110 may be mechanical, pneumatic, hydraulic, or combinations thereof to pressurize the internal volume 1106 of the mixing reservoir 1102.

In some embodiments, pressurizing the internal volume 1106 of the mixing reservoir 1102 may cause a fluid, such as paint, to flow from the internal volume 1106 of the mixing reservoir 1102, through an optional filter 1112, through the tube connection 1108 to deliver paint to a flexible reservoir 104, 204, 304, 404, 504, 604, 704, 1004. In some embodiments, a pump 710, 1010 of a reservoir assembly 750, 1050 may be reversible such that the pump 710, 1010 may draw fluid from the mixing apparatus 1100, through the tube 706, 1006 and into the flexible reservoir 704, 1104. As such, in embodiments comprising a pump 710, 1010, the pressure mechanism 1110 may not be employed. Thus, manual steps of pouring mixed paint or other surface enhancing liquids into a reservoir of a hand held spray device 102 may be eliminated and fully automated by the mixing apparatus 1100.

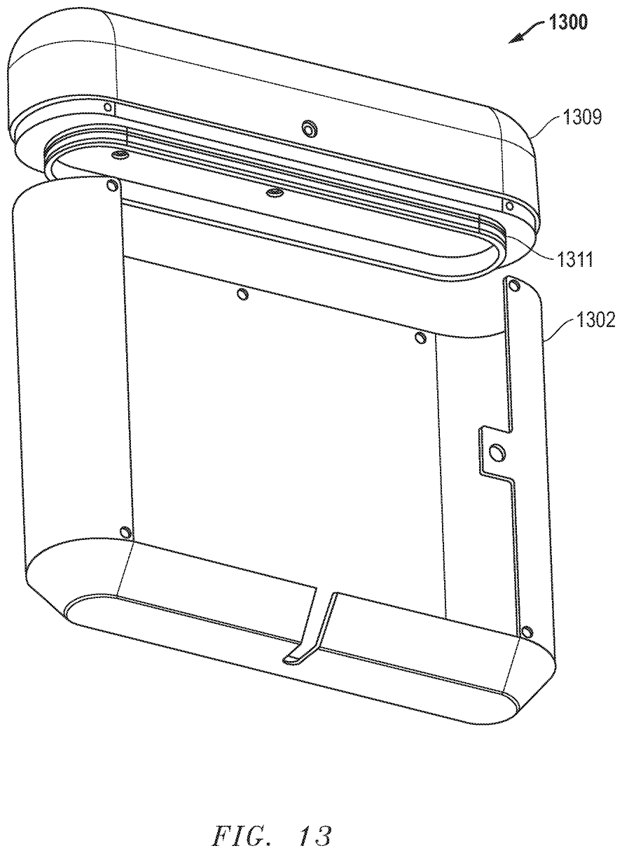

FIG. 12 is an oblique side view of a reservoir assembly 1200 according to another embodiment of the disclosure. In the embodiment shown, the reservoir assembly 1200 is shown without a flexible reservoir, such as flexible reservoir 104, 204, 304, 404, 504, 604, 704, 1004. The reservoir assembly 1200 may generally be substantially similar to one or more of reservoir assemblies 200, 300, 400, 500 in that the reservoir assembly 1200 comprises a rigid tank 1202, a flexible reservoir (not pictured) received within the rigid tank 1202, a tube (not pictured) connecting the flexible reservoir in fluid communication with a hand held spraying device 102, and a pressure device 1208. However, in the embodiment shown, the pressure device 1208 comprises a clamshell body collectively formed by a first rigid plate 1210 having a flange 1212, a second rigid plate 1214, and at least one spring 1216 configured to bias the second rigid plate 1214 towards first rigid plate 1210 to impart pressure to the flexible reservoir when the flexible reservoir is positioned between the plates 1210, 1214. The reservoir assembly 1200 may generally be configured to be worn by a user 110 in a substantially similar manner to reservoir assemblies 104, 200, 300, 400, 500. In some embodiments, the first rigid plate 1210 may comprise loops 1218 configured to receive a band, belt, straps, and/or other mechanism to secure the reservoir assembly 1200 to a user 110. Furthermore, in some embodiments, the flange 1212 of the second plate 1210 may comprise a cutout or relief 1220 configured to receive the tube 106, 206, 306, 406, 506, 706, 1006 of the flexible reservoir 104, 204, 304, 404, 504, 604, 704, 1004.

FIG. 13 shows an oblique view of a reservoir assembly 1300 according to an embodiment of the disclosure. The reservoir assembly 1300 may be worn by a user 110. In a specific embodiment, the reservoir assembly 1300 may be configured to be worn on the arm of a user 110. In another specific embodiment, the reservoir assembly 1300 may be configured to be worn on the back of a user 110. In some embodiments, the reservoir assembly 1300 may be substantially similar to or representative of one of the flexible reservoirs 400, 500, 650, 750, 1050. In a specific embodiment, the reservoir assembly 1300 may be substantially similar to or representative of the flexible reservoir 750. In a specific embodiment, the reservoir assembly 1300 may be substantially similar to or representative of the flexible reservoir 1050.

The reservoir assembly 1300 may generally comprise a rigid tank 1302 and a cover 1309. The rigid tank 1302 may be suitable for receiving a flexible reservoir, such as any of the flexible reservoirs 104, 204, 304, 404, 504, 604, 704, 1004 disclosed herein. In some embodiments, the rigid tank 1302 may be substantially similar to or representative of any of the rigid tanks 202, 302, 402, 502, 602, 702, 1002, 1102, 1202 disclosed herein. In a specific embodiment, the rigid tank 1302 may be substantially similar to or representative of the rigid tank 702. In another specific embodiment, the rigid tank 1302 may be substantially similar to or representative of the rigid tank 1002. In the embodiment shown, the rigid tank 1302 may be formed by an additive manufacturing process, such as 3D printing. Further, in some embodiments, each of the rigid tanks 202, 302, 402, 502, 602, 702, 1002, 1102, 1202 disclosed herein may also be formed by an additive manufacturing process, such as 3D printing.

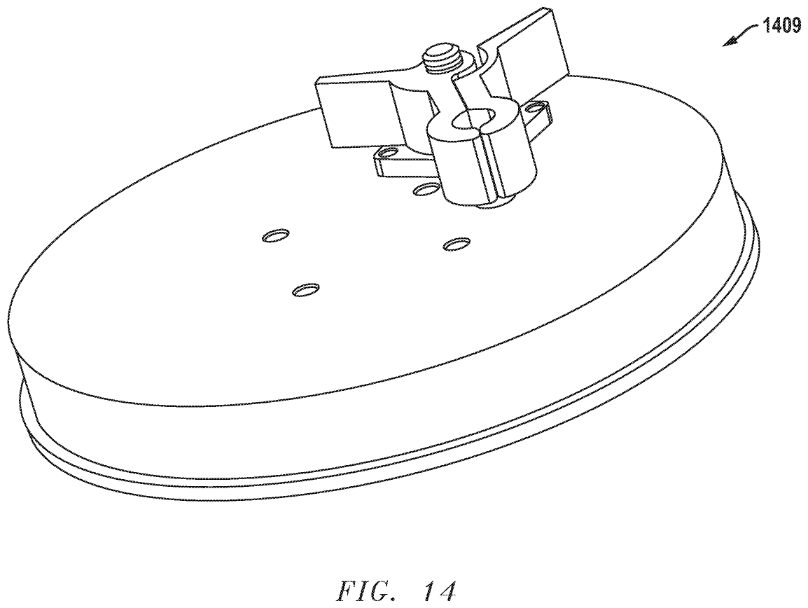

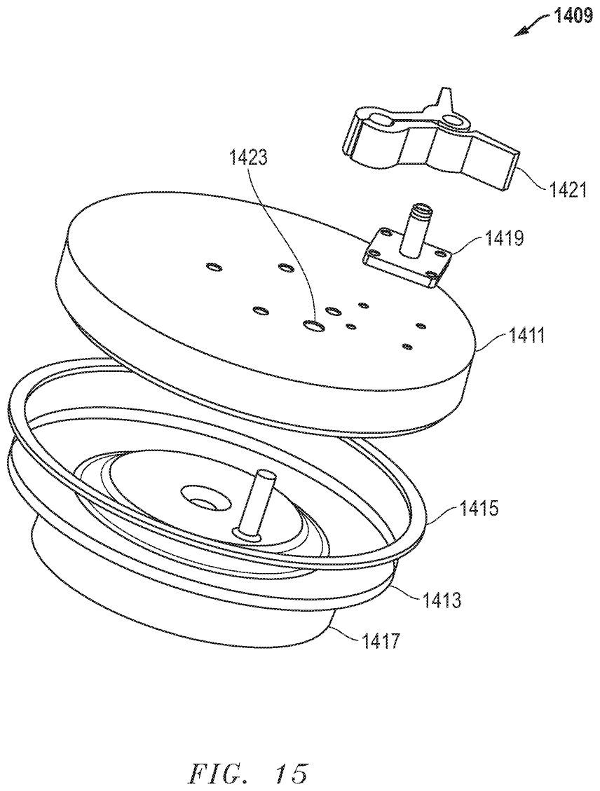

In some embodiments, the cover 1309 may be configured to carry a pump 710, 1010, a battery 712, 1012, and/or a pressure regulator 714, 1014. As such it will be appreciated that the cover 1309 may comprise one or more holes, passages, ports, or recesses. In some embodiments, the cover 1309 may be substantially similar to or representative of any of the covers 409, 509, 609, 709, 1009, 1104 disclosed herein. In a specific embodiment, the cover 1309 may be substantially similar to or representative of the cover 709. In another specific embodiment, the cover 1309 may be substantially similar to or representative of the cover 1009. In some embodiments, the cover 1309 may generally comprise one or more features, such a flange 1311, which may enable proper alignment and/or fluid tight sealing between the cover with the rigid tank 1302. In the embodiment shown, the cover 1309 may be formed by an additive manufacturing process, such as 3D printing. Further, in some embodiments, each of the covers 409, 509, 609, 709, 1009, 1104 disclosed herein may also be formed by an additive manufacturing process, such as 3D printing. Furthermore, in some embodiments, any of the components (e.g., components 104, 204, 208, 209, 308, 309, 310, 1210, 1214 of the reservoir assemblies 100, 200, 300, 400, 500, 650, 750, 1050, 1100, 1200 may be formed by an additive manufacturing process, such as 3D printing. FIGS. 14 and 15 show an oblique view and an oblique exploded view of a cover 1409 according to an embodiment of the disclosure. In some embodiments, the cover 1409 may be substantially similar to or representative of any of the covers 409, 509, 609, 709, 1009, 1104, 1309 disclosed herein and be suitable for use in one or more of the reservoir assemblies 400, 500, 650, 750, 1050, 1200, 1300 and/or one or more of the mixing apparatuses 722, 1100 disclosed herein. In a specific embodiment, the cover 1409 may be substantially similar to or representative of the cover 1104 of the mixing apparatus 100. In the embodiment shown, the cover 1409 comprises a main body component 1411 and a secondary body component 1413. In some embodiments, a gasket 1415 may be disposed between the main body component 1411 and the secondary body component 1413. However, in some embodiments, the main body component 1411 and the secondary body component 1413 may be a unitary component, and the gasket 1415 may be used to seal the cover 1409 to a reservoir on which the cover 1409 is mounted.

In some embodiments, the main body component 1411 may comprise one or more holes, passages, ports, or recesses 1423 to allow for a tube connection 1108 to pass through the cover 1409. In some embodiments, this may facilitate addition and/or removal of a fluid from a reservoir on which the cover 1409 is mounted. In some embodiments, the main body component 1411 may comprise threaded holes configured to receive fasteners therethrough in order to carry one or more components 1419, 1421 that may affix another component to the cover 1409. In some embodiments, the cover 1409 may also comprise a lower component 1417, which may be a filter such as filter 1112, or other component that may aid in removing contaminants from a fluid extracted from a reservoir on which the cover 1409 is mounted. In the embodiment shown, one or more of the components 1411, 1413, 1415, 1417, 1419, 1421 of the cover 1409 may be formed by an additive manufacturing process, such as 3D printing. In a specific embodiment, the main body component 1411 and the secondary body component 1413 are formed by an additive manufacturing process, such as 3D printing. In another specific embodiment, the main body component 1411, the secondary body component 1413, and the gasket 1415 are formed by an additive manufacturing process, such as 3D printing.

In still other embodiments, the spraying apparatus may include one or more of the following items:

Embodiment 1. A spraying apparatus, comprising: a hand held spraying device; a reservoir assembly comprising a flexible reservoir connected in fluid communication with the hand held spraying device, wherein the reservoir assembly is configured to be worn on the body of a user of the spraying apparatus; and a pressure device configured to provide pressure to the flexible reservoir.

Embodiment 2. The spraying apparatus of embodiment 1, wherein the pressure device provides sufficient pressure to move fluid from the flexible reservoir to the hand held spraying device.

Embodiment 3. The spraying apparatus of embodiment 2, further comprising: at least one of a pressure gauge and a pressure regulator configured to assist the user in maintaining proper pressure in the flexible reservoir.

Embodiment 4. The spraying apparatus of embodiment 2, wherein the pressure device provides at least 1 meter of H₂O pressure (about 1.42 pounds per square inch), such as at least 1.5 meters of H₂O pressure (about 2.13 pounds per square inch), at least 2 meters of H₂O pressure (about 2.84 pounds per square inch), at least 3 meters of H₂O pressure (about 4.27 pounds per square inch), at least 4 meters of H₂O pressure (about 5.69 pounds per square inch), at least 5 meters of H₂O pressure (about 7.11 pounds per square inch), or at least 10 meters of H₂O pressure (about 14.22 pounds per square inch) to the flexible reservoir.

Embodiment 5. The spraying apparatus of embodiment 1, wherein the pressure device comprises a resilient band or strap configured to secure the flexible reservoir to the user.

Embodiment 6. The spraying apparatus of embodiment 5, wherein the resilient band or strap extends at least partially around the flexible reservoir to provide pressure to the flexible reservoir and at least partially around a portion of the body of the user to secure the flexible reservoir to the body of the user.

Embodiment 7. The spraying apparatus of embodiment 1, wherein the reservoir assembly further comprises a rigid tank, and wherein the flexible reservoir is received within the rigid tank.

Embodiment 8. The spraying apparatus of embodiment 7, wherein the flexible reservoir is removable from the rigid tank.

Embodiment 9. The spraying apparatus of embodiment 8, wherein the rigid tank is configured to receive various sized flexible reservoirs.

Embodiment 10. The spraying apparatus of embodiment 1, wherein the flexible reservoir comprises a volume of at least about 150 cubic centimeters, such as at least about 200 cubic centimeters, at least about 250 cubic centimeters, at least about 300 cubic centimeters, at least about 350 cubic centimeters, at least about 500 cubic centimeters, at least about 750 cubic centimeters, at least about 1000 cubic centimeters, at least about 1500 cubic centimeters, at least about 2000 cubic centimeters, or at least about 2500 cubic centimeters

Embodiment 11. The spraying apparatus of embodiment 1, wherein flexible reservoir is sealable.

Embodiment 12. The spraying apparatus of embodiment 1, wherein the flexible reservoir is connected in fluid communication with the hand held spraying device via a tube.

Embodiment 13. The spraying apparatus of embodiment 12, wherein the tube comprises an inner diameter of at least about 3 millimeters, such as at least about 4 millimeters, at least about 5 millimeters, at least about 6 millimeters, at least about 7 millimeters, at least about 8 millimeters, at least about 9 millimeters, at least about 10 millimeters, at least about 12 millimeters, at least about 15 millimeters, at least about 20 millimeters, or at least about 25 millimeters.

Embodiment 14. The spraying apparatus of embodiment 7, wherein an internal volume of the flexible reservoir is selectively adjustable by the pressure device.

Embodiment 15. The spraying apparatus of embodiment 14, wherein the pressure device comprises a plate.

Embodiment 16. The spraying apparatus of embodiment 14, wherein the pressure device comprises a selectively rotatable splined shaft configured to interact with complementary splines of the rigid tank.

Embodiment 17. The spraying apparatus of embodiment 16, wherein rotation of the splined shaft in a first direction increases the pressure imparted to the flexible reservoir, and wherein rotation of the splined shaft in a second opposing direction relieves the pressure imparted to the flexible reservoir.

Embodiment 18. The spraying apparatus of embodiment 7, wherein the rigid tank comprises a cover selectively securable to the rigid tank.

Embodiment 19. The spraying apparatus of embodiment 18, further comprising: at least one spring configured to bias the flexible reservoir away from the cover to impart pressure to the flexible reservoir.

Embodiment 20. The spraying apparatus of embodiment 18, further comprising: a manual pump and an inflatable diaphragm coupled to the manual pump, wherein the manual pump is selectively operable to pressurize the inflatable diaphragm to impart pressure to the flexible reservoir.

Embodiment 21. The spraying apparatus of embodiment 20, wherein the manual pump comprises a selectively operable pressure relief valve.

Embodiment 22. The spraying apparatus of embodiment 7, further comprising: a Y adapter comprising an inlet connected to an air compressor, a first branch connected to the flexible reservoir, and a second branch connected to the hand held spraying device.

Embodiment 23. The spraying apparatus of embodiment 22, further comprising: a pressure regulator disposed between the first branch of the Y-adapter and the flexible reservoir.

Embodiment 24. The spraying apparatus of embodiment 23, wherein the pressure regulator allows the user to control the pressure in the flexible reservoir between at least about 0 PSI and 120 PSI.

Embodiment 25. The spraying apparatus of embodiment 24, wherein the pressure provided to the flexible reservoir is less than the pressure provided to the hand held spraying device.

Embodiment 26. The spraying apparatus of embodiment 7, wherein the pressure device comprises a pump configured to provide pressure the flexible reservoir.

Embodiment 27. The spraying apparatus of embodiment 26, further comprising: a pressure regulator configured to regulate the pressure provided by the pump to the flexible reservoir, and a battery configured to provide power to the pump.

Embodiment 28. The spraying apparatus of embodiment 27, wherein the rigid tank comprises a cover configured to carry the battery, the pump, and the pressure regulator.

Embodiment 29. The spraying apparatus of embodiment 1, wherein the hand held spraying device is connected to an air compressor and configured to spray the paint in response to the user selectively operating a mechanism of the hand held spraying device.

Embodiment 30. The spraying apparatus of embodiment 1, wherein the reservoir assembly is worn on an arm, back, leg, or waist of the user.

Embodiment 31. A spraying apparatus, comprising: a hand held spraying device; and a reservoir assembly, comprising: a flexible reservoir connected in fluid communication with the hand held spraying device; and a pump configured to provide pressure to the flexible reservoir; wherein the reservoir assembly is configured to be worn on the body of a user of the spraying apparatus.

Embodiment 32. The spraying apparatus of embodiment 31, further comprising: a rigid tank, wherein the flexible reservoir is received within the rigid tank, and wherein the flexible reservoir is removable from the rigid tank.

Embodiment 33. The spraying apparatus of embodiment 32, wherein the rigid tank is configured to receive various sized flexible reservoirs.

Embodiment 34. The spraying apparatus of embodiment 32, wherein the pump is carried by the rigid tank.

Embodiment 35. The spraying apparatus of embodiment 34, further comprising: a battery carried by the rigid tank and configured to provide power to the pump.

Embodiment 36. The spraying apparatus of embodiment 35, wherein the battery is rechargeable.

Embodiment 37. The spraying apparatus of embodiment 31, wherein the flexible reservoir comprises a volume of at least about 150 cubic centimeters, such as at least about 200 cubic centimeters, at least about 250 cubic centimeters, at least about 300 cubic centimeters, at least about 350 cubic centimeters, at least about 500 cubic centimeters, at least about 750 cubic centimeters, at least about 1000 cubic centimeters, at least about 1500 cubic centimeters, at least about 2000 cubic centimeters, or at least about 2500 cubic centimeters.

Embodiment 38. The spraying apparatus of embodiment 31, wherein the pump provides sufficient pressure to move fluid from the flexible reservoir to the hand held spraying device.

Embodiment 39. The spraying apparatus of embodiment 38, wherein the pump provides at least 1 meter of H₂O pressure (about 1.42 pounds per square inch), such as at least 1.5 meters of H₂O pressure (about 2.13 pounds per square inch), at least 2 meters of H₂O pressure (about 2.84 pounds per square inch), at least 3 meters of H₂O pressure (about 4.27 pounds per square inch), at least 4 meters of H₂O pressure (about 5.69 pounds per square inch), at least 5 meters of H₂O pressure (about 7.11 pounds per square inch), or at least 10 meters of H₂O pressure (about 14.22 pounds per square inch).

Embodiment 40. The spraying apparatus of embodiment 31, wherein the flexible reservoir is connected in fluid communication with the hand held spraying device via a tube.

Embodiment 41. The spraying apparatus of embodiment 40, wherein the tube comprises an inner diameter of at least about 3 millimeters, such as at least about 4 millimeters, at least about 5 millimeters, at least about 6 millimeters, at least about 7 millimeters, at least about 8 millimeters, at least about 9 millimeters, at least about 10 millimeters, at least about 12 millimeters, at least about 15 millimeters, at least about 20 millimeters, or at least about 25 millimeters.

Embodiment 42. The spraying apparatus of embodiment 40, wherein the tube comprises a valve configured to selectively restrict the flow or fluid through the tube.

Embodiment 43. The spraying apparatus of embodiment 40, wherein the tube comprises a first end connected to the flexible reservoir and a second end connected to the hand held spraying device.

Embodiment 44. The spraying apparatus of embodiment 43, wherein the second end is configured to be disconnected from the hand held spraying device and connected to a mixing apparatus.

Embodiment 45. The spraying apparatus of embodiment 44, wherein the pump is reversible to draw a fluid from the mixing apparatus into the flexible reservoir.

Embodiment 46. The spraying apparatus of embodiment 31, wherein the pressure regulator is selectively adjustable to control the flow of fluid to the hand held spraying device.

Embodiment 47. The spraying apparatus of embodiment 46, wherein the pressure regulator allows the user to control the pressure in the flexible reservoir between at least about 0 PSI and 120 PSI.

Embodiment 48. The spraying apparatus of embodiment 46, wherein the fluid comprises paint.

Embodiment 49. The spraying apparatus of embodiment 47, wherein the hand held spraying device is connected to an air compressor and configured to spray the paint in response to the user selectively operating a mechanism of the hand held spraying device.

Embodiment 50. The spraying apparatus of embodiment 31, wherein the reservoir assembly is worn on an arm, back, leg, or waist of the user.

Embodiment 51. The spraying apparatus of embodiment 1 or 31, wherein the reservoir assembly is further configured to hung, mounted, or otherwise secured to a stationary structure.

Embodiment 52. A spraying apparatus, comprising: a hand held spraying device; a reservoir assembly comprising a flexible reservoir connected in fluid communication with the hand held spraying device, wherein the reservoir assembly is configured to be worn on the body of a user of the spraying apparatus; a first pressure source configured to force fluid from the flexible reservoir to the hand held spraying device; and a second pressure source configured to discharge the fluid through a nozzle of the hand held spraying device in response to operation of a mechanism of the hand held spraying device.

Embodiment 53. The spraying apparatus of embodiment 52, wherein the first pressure source is different than the second pressure source.

Embodiment 54. The spraying apparatus of embodiment 53, wherein the first pressure source provides a first pressure to the flexible reservoir, and wherein the second pressure source provides a second pressure to the hand held spraying device that is greater than the first pressure.

Embodiment 55. The spraying apparatus of embodiment 52, wherein the reservoir assembly is further configured to hung, mounted, or otherwise secured to a stationary structure.

Embodiment 56. A method of operating a spraying apparatus, comprising: providing a reservoir assembly comprising a flexible reservoir; securing the reservoir assembly to the body of a user; connecting the flexible reservoir in fluid communication with a hand held spraying device; selectively adjusting the pressure supplied to the flexible reservoir; and operating a mechanism of the hand held spraying device to discharge a fluid carried by the flexible reservoir from the hand held spraying device.

Embodiment 57. The spraying apparatus of embodiment 7, wherein the pressure device comprises a clamshell body collectively formed by a first rigid plate, a second rigid plate, and at least one spring configured to bias the second rigid plate towards first rigid plate to impart pressure to the flexible reservoir when the flexible reservoir is positioned between the first rigid plate and the second rigid plate.

Embodiment 58. The spraying apparatus of embodiment 31, wherein the pump is configured to provide pressure to the flexible reservoir via an inflatable diaphragm coupled to the fluid pump.

Embodiment 59. The spraying apparatus of embodiment 31, wherein the inflatable diaphragm is carried by the rigid tank.

Embodiment 60. A spraying apparatus, comprising: a hand held spraying device; and a reservoir assembly, comprising: a flexible reservoir connected in fluid communication with the hand held spraying device; and a pump configured to provide pressure to the flexible reservoir; wherein the reservoir assembly is configured to be worn on the body of a user of the spraying apparatus.

Embodiment 61. The spraying apparatus of embodiment 60, further comprising: a rigid tank, wherein the flexible reservoir is received within the rigid tank, and wherein the flexible reservoir is removable from the rigid tank.

Embodiment 62. The spraying apparatus of embodiment 61, wherein the pump is carried by a cover of the rigid tank.

Embodiment 63. The spraying apparatus of embodiment 62, further comprising: a battery carried by the cover of the rigid tank and configured to provide power to the pump.

Embodiment 64. The spraying apparatus of embodiment 63, wherein the battery is rechargeable.

Embodiment 65. The spraying apparatus of embodiment 60, wherein the flexible reservoir comprises a volume of at least about 150 cubic centimeters, such as at least about 200 cubic centimeters, at least about 250 cubic centimeters, at least about 300 cubic centimeters, at least about 350 cubic centimeters, at least about 500 cubic centimeters, at least about 750 cubic centimeters, at least about 1000 cubic centimeters, at least about 1500 cubic centimeters, at least about 2000 cubic centimeters, or at least about 2500 cubic centimeters.

Embodiment 66. The spraying apparatus of embodiment 60, wherein the pump provides sufficient pressure to move fluid from the flexible reservoir to the hand held spraying device.

Embodiment 67. The spraying apparatus of embodiment 66, wherein the pump provides at least 1 meter of H₂O pressure (about 1.42 pounds per square inch), such as at least 1.5 meters of H₂O pressure (about 2.13 pounds per square inch), at least 2 meters of H₂O pressure (about 2.84 pounds per square inch), at least 3 meters of H₂O pressure (about 4.27 pounds per square inch), at least 4 meters of H₂O pressure (about 5.69 pounds per square inch), at least 5 meters of H₂O pressure (about 7.11 pounds per square inch), or at least 10 meters of H₂O pressure (about 14.22 pounds per square inch).

Embodiment 68. The spraying apparatus of embodiment 60, wherein the flexible reservoir is connected in fluid communication with the hand held spraying device via a tube.

Embodiment 69. The spraying apparatus of embodiment 68, wherein an end of the tube is configured to be disconnected from the hand held spraying device and connected to a mixing apparatus.

Embodiment 70. The spraying apparatus of embodiment 69, wherein the pump is reversible to draw a fluid from the mixing apparatus into the flexible reservoir.

Embodiment 71. The spraying apparatus of embodiment 60, further comprising: a pressure regulator configured to regulate the pressure provided by the pump to the flexible reservoir, wherein the pressure regulator allows the user to control the pressure in the flexible reservoir between at least about 0 PSI and 120 PSI.

Embodiment 72. The spraying apparatus of embodiment 71, wherein the pressure regulator is carried by a cover of the rigid tank.

Embodiment 73. The spraying apparatus of embodiment 60, wherein the hand held spraying device is connected to an air compressor and configured to spray the paint in response to the user selectively operating a mechanism of the hand held spraying device.

Embodiment 74. The spraying apparatus of embodiment 60, wherein the reservoir assembly is configured to be worn on an arm, back, leg, or waist of the user, and wherein the reservoir assembly is further configured to hung, mounted, or otherwise secured to a stationary structure.

Embodiment 75. The spraying apparatus of any of the preceding embodiments, wherein the cover comprises a filter.

Embodiment 76. The spraying apparatus of any of the preceding embodiments, wherein the rigid tank is formed by an additive manufacturing process.

Embodiment 77. The spraying apparatus of any of the preceding embodiments, wherein the cover is formed by an additive manufacturing process.

This written description uses examples to disclose the embodiments, including the best mode, and also to enable those of ordinary skill in the art to make and use the invention. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

1. A spraying apparatus, comprising:
a reservoir assembly, comprising:
a flexible reservoir configured to be connected in fluid communication with a hand held spraying device; and
a pump configured to provide pressure to the flexible reservoir;
wherein the reservoir assembly is configured to be worn on the body of a user of the spraying apparatus.

2. The spraying apparatus of claim 1, further comprising: a rigid tank, wherein the flexible reservoir is received within the rigid tank, and wherein the flexible reservoir is removable from the rigid tank.

3. The spraying apparatus of claim 2, wherein the pump is carried by a cover of the rigid tank.

4. The spraying apparatus of claim 3, further comprising: a battery carried by the cover of the rigid tank and configured to provide power to the pump.

5. The spraying apparatus of claim 4, wherein the battery is rechargeable.

6. The spraying apparatus of claim 1, wherein the flexible reservoir comprises a volume of at least about 150 cubic centimeters.

7. The spraying apparatus of claim 1, wherein the pump provides sufficient pressure to move fluid from the flexible reservoir to the hand held spraying device.

8. The spraying apparatus of claim 7, wherein the pump provides at least 1 meter of H₂O pressure.

9. The spraying apparatus of claim 1, wherein the flexible reservoir is connected in fluid communication with the hand held spraying device via a tube.

10. The spraying apparatus of claim 9, wherein an end of the tube is configured to be disconnected from the hand held spraying device and connected to a mixing apparatus.

11. The spraying apparatus of claim 10, wherein the pump is reversible to draw a fluid from the mixing apparatus into the flexible reservoir.

12. The spraying apparatus of claim 1, further comprising: a pressure regulator configured to regulate the pressure provided by the pump to the flexible reservoir, wherein the pressure regulator allows the user to control the pressure in the flexible reservoir between at least about 0 PSI and 120 PSI.

13. The spraying apparatus of claim 12, wherein the pressure regulator is carried by a cover of the rigid tank.

14. The spraying apparatus of claim 1, wherein the hand held spraying device is connected to an air compressor and configured to spray the paint in response to the user selectively operating a mechanism of the hand held spraying device.

15. The spraying apparatus of claim 1, wherein the reservoir assembly is configured to be worn on an arm, back, leg, or waist of the user, and wherein the reservoir assembly is further configured to hung, mounted, or otherwise secured to a stationary structure.

16. The spraying apparatus of claim 1, wherein the flexible reservoir is sealable.

17. The spraying apparatus of claim 1, further comprising: at least one of a pressure gauge and a pressure regulator.

18. The spraying apparatus of claim 1, wherein the flexible reservoir comprises a volume of at least about 150 cubic centimeters.

19. The spraying apparatus of claim 1, wherein the rigid tank comprises a cover selectively securable to the rigid tank.

20. A method of operating a spraying apparatus, comprising:
providing a reservoir assembly comprising a flexible reservoir;
securing the reservoir assembly to the body of a user;
connecting the flexible reservoir in fluid communication with a hand held spraying device;
selectively adjusting the pressure supplied to the flexible reservoir; and
operating a mechanism of the hand held spraying device to discharge a fluid carried by the flexible reservoir from the hand held spraying device.
